(19) United States
(12) Patent Application Publication
(10) Pub. No.: US 2026/0074856 A1
(43) Pub. Date: Mar. 12, 2026

(54) REFERENCE SIGNAL DESIGN FOR PASSIVE WIRELESS DEVICES

(71) Applicant: QUALCOMM Incorporated, San Diego, CA (US)

(72) Inventors: Ahmed ELSHAFIE, San Diego, CA (US); Yuchul KIM, San Diego, CA (US); Zhikun WU, Beijing (CN); Huilin XU, Temecula, CA (US); Seyedkianoush HOSSEINI, San Diego, CA (US); Linhai HE, San Diego, CA (US)

(21) Appl. No.: 19/106,026

(22) PCT Filed: Oct. 26, 2022
(86) PCT No.: PCT/CN2022/127560

§ 371 Date: Feb. 24, 2025

(51) Int. Cl. H04L 5/00

(52) U.S. Cl. CPC H04L 5/0048

(57) ABSTRACT

Methods, systems, and devices for wireless communications are described. A wireless device, such as a radio frequency identifier (RFID) device, may receive a trigger message from another wireless device via a continuous radio frequency (RF) waveform that activates the RFID device. The trigger message may include one or more parameters for a channel state information (CSI) report, one or more sounding reference signals (SRSs), or both. The RFID device may send the CSI report, the SRSs, or both in a message via a portion of a modulated continuous RF waveform. The contents of the message may be based on the parameters and a capability of the RFID device.

### CROSS REFERENCE

The present Application is a 371 national phase filing of International PCT Application No. PCT/CN2022/127560 by ELSHAFIE et al., entitled “REFERENCE SIGNAL DESIGN FOR PASSIVE WIRELESS DEVICES,” filed Oct. 26, 2022, which is assigned to the assignee hereof, and which is expressly incorporated by reference in its entirety herein.

### TECHNICAL FIELD

The following relates to wireless communications, including reference signal design for passive wireless devices.

### BACKGROUND

Wireless communications systems are widely deployed to provide various types of communication content such as voice, video, packet data, messaging, broadcast, and so on. These systems may be capable of supporting communication with multiple users by sharing the available system resources (e.g., time, frequency, and power). Examples of such multiple-access systems include fourth generation (4G) systems such as Long Term Evolution (LTE) systems, LTE-Advanced (LTE-A) systems, or LTE-A Pro systems, and fifth generation (5G) systems which may be referred to as New Radio (NR) systems. These systems may employ technologies such as code division multiple access (CDMA), time division multiple access (TDMA), frequency division multiple access (FDMA), orthogonal FDMA (OFDMA), or discrete Fourier transform spread orthogonal frequency division multiplexing (DFT-S-OFDM). A wireless multiple-access communications system may include one or more base stations, each supporting wireless communication for communication devices, which may be known as user equipment (UE).

### SUMMARY

The described techniques relate to improved methods, systems, devices, and apparatuses that support reference signal design for passive wireless devices. For example, the described techniques provide for a wireless device to configure a radio frequency identification (RFID) device (e.g., a passive tag, semi-passive tag, semi-active tag, or any other type of RFID device) with one or more parameters for sending a channel state information (CSI) report, backscattering a sounding reference signal (SRS), or both. For example, the wireless device may send a continuous radio frequency (RF) waveform that activates the RFID device. Once the device is active, the wireless device may send a trigger message to the RFID device indicating the one or more parameters. The parameters may be sent to the wireless device by a control node or may be determined at the wireless device. The RFID device may send a message including the CSI report, the backscattered SRS, or both in accordance with the parameters and a capability of the RFID device.

A method for wireless communication at a first wireless device is described. The method may include receiving, via a continuous RF waveform that activates the first wireless device, a trigger message from a second wireless device, the trigger message indicating one or more parameters associated with a reference signal associated with the first wireless device and the second wireless device, modulating the continuous RF waveform based on the reference signal, and sending, via a portion of the modulated continuous RF waveform, a message associated with the reference signal based on the one or more parameters and a capability of the first wireless device.

An apparatus for wireless communication at a first wireless device is described. The apparatus may include at least one processor and memory coupled with the at least one processor, the memory storing instructions. The instructions may be executable by the at least one processor to cause the apparatus to receive, via a continuous RF waveform that activates the first wireless device, a trigger message from a second wireless device, the trigger message indicating one or more parameters associated with a reference signal associated with the first wireless device and the second wireless device, modulate the continuous RF waveform based on the reference signal, and send, via a portion of the modulated continuous RF waveform, a message associated with the reference signal based on the one or more parameters and a capability of the first wireless device.

Another apparatus for wireless communication at a first wireless device is described. The apparatus may include means for receiving, via a continuous RF waveform that activates the first wireless device, a trigger message from a second wireless device, the trigger message indicating one or more parameters associated with a reference signal associated with the first wireless device and the second wireless device, means for modulating the continuous RF waveform based on the reference signal, and means for sending, via a portion of the modulated continuous RF waveform, a message associated with the reference signal based on the one or more parameters and a capability of the first wireless device.

A non-transitory computer-readable medium storing code for wireless communication at a first wireless device is described. The code may include instructions executable by a processor to receive, via a continuous RF waveform that activates the first wireless device, a trigger message from a second wireless device, the trigger message indicating one or more parameters associated with a reference signal associated with the first wireless device and the second wireless device, modulate the continuous RF waveform based on the reference signal, and send, via a portion of the modulated continuous RF waveform, a message associated with the reference signal based on the one or more parameters and a capability of the first wireless device.

Some examples of the method, apparatuses, and non-transitory computer-readable medium described herein may further include operations, features, means, or instructions for performing, in response to the trigger message, one or more operations based on the capability of the first wireless device and the one or more parameters.

Some examples of the method, apparatuses, and non-transitory computer-readable medium described herein may further include operations, features, means, or instructions for performing the one or more operations includes measuring CSI associated with the reference signal and sending the message includes sending a CSI report including the CSI.

In some examples of the method, apparatuses, and non-transitory computer-readable medium described herein, sending the message may include operations, features, means, or instructions for sending an SRS via the portion of the modulated continuous RF waveform based on the one or more parameters.

Some examples of the method, apparatuses, and non-transitory computer-readable medium described herein may further include operations, features, means, or instructions for receiving, via the continuous RF waveform, a capability enquiry message and sending, via the continuous RF waveform, a capability message indicating the capability of the first wireless device based on receiving the capability enquiry message.

In some examples of the method, apparatuses, and non-transitory computer-readable medium described herein, receiving the trigger message may include operations, features, means, or instructions for receiving the trigger message including a scrambling sequence dedicated for the first wireless device, dedicated for the reference signal, or both.

In some examples of the method, apparatuses, and non-transitory computer-readable medium described herein, sending the message may include operations, features, means, or instructions for sending an SRS via the continuous RF waveform during an uplink slot, a downlink slot, or both.

In some examples of the method, apparatuses, and non-transitory computer-readable medium described herein, sending the message may include operations, features, means, or instructions for sending a CSI report via the continuous RF waveform during the uplink slot, the downlink slot, or both.

Some examples of the method, apparatuses, and non-transitory computer-readable medium described herein may further include operations, features, means, or instructions for performing a port sounding procedure associated with the reference signal based on a quantity of antennas at the first wireless device.

In some examples of the method, apparatuses, and non-transitory computer-readable medium described herein, the one or more parameters indicate an order or a rank for the port sounding procedure.

In some examples of the method, apparatuses, and non-transitory computer-readable medium described herein, the capability of the first wireless device may be based at least on a device class associated with one or more reference signal configurations, a first storage for the one or more reference signal configurations, one or more message configurations, a second storage for the one or more message configurations, an SRS, a port sounding capability, or any combination thereof.

In some examples of the method, apparatuses, and non-transitory computer-readable medium described herein, the one or more message configurations indicates a reference signal sequence, a resource allocation associated with the reference signal, requested content for the message, a charging rate, an input power level, a power measurement, a pathloss measurement, a signal quality measurement, an SRS trigger, an SRS sequence, a timing parameter, or any combination thereof.

In some examples of the method, apparatuses, and non-transitory computer-readable medium described herein, sending the message may include operations, features, means, or instructions for sending, via the portion of the modulated continuous RF waveform, an indication of at least one of a capacitor size, the device class, a power splitting circuit, a power splitting factor, a condition for performing power splitting, an energy capacity time, and a communication or backscattering time.

In some examples of the method, apparatuses, and non-transitory computer-readable medium described herein, the one or more parameters indicate orthogonal resources in a time or frequency domain based on the port sounding capability.

In some examples of the method, apparatuses, and non-transitory computer-readable medium described herein, the one or more parameters indicate one or more antenna ports associated with data communication at the first wireless device.

Some examples of the method, apparatuses, and non-transitory computer-readable medium described herein may further include operations, features, means, or instructions for sending, via the portion of the modulated continuous RF waveform, an additional report message indicating an input power level.

In some examples of the method, apparatuses, and non-transitory computer-readable medium described herein, the one or more parameters associated with the reference signal may be based on a memory capability of the first wireless device.

In some examples of the method, apparatuses, and non-transitory computer-readable medium described herein, a memory of the first wireless device may be associated with the capability of the first wireless device in a current communication period, a previous communication period, or both.

A method for wireless communication at a first wireless device is described. The method may include transmitting, via a continuous RF waveform that activates a second wireless device, a trigger message to the second wireless device, the trigger message indicating one or more parameters associated with a reference signal associated with the first wireless device and the second wireless device and receiving, via a modulated portion of the continuous RF waveform, a message associated with the reference signal based on the one or more parameters and a capability of the second wireless device.

An apparatus for wireless communication at a first wireless device is described. The apparatus may include at least one processor and memory coupled with the at least one processor, the memory storing instructions. The instructions may be executable by the at least one processor to cause the apparatus to transmit, via a continuous RF waveform that activates a second wireless device, a trigger message to the second wireless device, the trigger message indicating one or more parameters associated with a reference signal associated with the first wireless device and the second wireless device and receive, via a modulated portion of the continuous RF waveform, a message associated with the reference signal based on the one or more parameters and a capability of the second wireless device.

Another apparatus for wireless communication at a first wireless device is described. The apparatus may include means for transmitting, via a continuous RF waveform that activates a second wireless device, a trigger message to the second wireless device, the trigger message indicating one or more parameters associated with a reference signal associated with the first wireless device and the second wireless device and means for receiving, via a modulated portion of the continuous RF waveform, a message associated with the reference signal based on the one or more parameters and a capability of the second wireless device.

A non-transitory computer-readable medium storing code for wireless communication at a first wireless device is described. The code may include instructions executable by a processor to transmit, via a continuous RF waveform that activates a second wireless device, a trigger message to the second wireless device, the trigger message indicating one or more parameters associated with a reference signal associated with the first wireless device and the second wireless device and receive, via a modulated portion of the continuous RF waveform, a message associated with the reference signal based on the one or more parameters and a capability of the second wireless device.

In some examples of the method, apparatuses, and non-transitory computer-readable medium described herein, receiving the message may include operations, features, means, or instructions for receiving a CSI report including CSI.

In some examples of the method, apparatuses, and non-transitory computer-readable medium described herein, receiving the message may include operations, features, means, or instructions for receiving an SRS via the modulated portion of the continuous RF waveform based on the one or more parameters.

Some examples of the method, apparatuses, and non-transitory computer-readable medium described herein may further include operations, features, means, or instructions for transmitting, via the continuous RF waveform, a capability enquiry message and receiving, via the continuous RF waveform, a capability message indicating the capability of the second wireless device based on receiving the capability enquiry message.

In some examples of the method, apparatuses, and non-transitory computer-readable medium described herein, transmitting the trigger message may include operations, features, means, or instructions for transmitting the trigger message including a scrambling sequence dedicated for the second wireless device, dedicated for the reference signal, or both.

In some examples of the method, apparatuses, and non-transitory computer-readable medium described herein, receiving the message may include operations, features, means, or instructions for receiving a SRS via the continuous RF waveform during an uplink slot, a downlink slot, or both.

In some examples of the method, apparatuses, and non-transitory computer-readable medium described herein, receiving the message may include operations, features, means, or instructions for receiving a CSI report via the continuous RF waveform during the uplink slot, the downlink slot, or both.

In some examples of the method, apparatuses, and non-transitory computer-readable medium described herein, the one or more parameters indicate an order or a rank for a port sounding procedure at the second wireless device.

In some examples of the method, apparatuses, and non-transitory computer-readable medium described herein, the capability of the second wireless device may be based at least on a device class associated with one or more reference signal configurations, a first storage for the one or more reference signal configurations, one or more message configurations, a second storage for the one or more message configurations, an SRS, a port sounding capability, or any combination thereof.

In some examples of the method, apparatuses, and non-transitory computer-readable medium described herein, the one or more message configurations indicates a reference signal sequence, a resource allocation associated with the reference signal, requested content for the message, a charging rate, an input power level, a power measurement, a pathloss measurement, a signal quality measurement, an SRS trigger, an SRS sequence, a timing parameter, or any combination thereof.

In some examples of the method, apparatuses, and non-transitory computer-readable medium described herein, sending the message may include operations, features, means, or instructions for receiving, via the modulated portion of the continuous RF waveform, an indication of at least one of a capacitor size, the device class, a power splitting circuit, a power splitting factor, a condition for performing power splitting, an energy capacity time, and a communication or backscattering time.

In some examples of the method, apparatuses, and non-transitory computer-readable medium described herein, the one or more parameters indicate orthogonal resources in a time or frequency domain based on the port sounding capability.

In some examples of the method, apparatuses, and non-transitory computer-readable medium described herein, the one or more parameters indicate one or more antenna ports associated with data communication at the second wireless device.

Some examples of the method, apparatuses, and non-transitory computer-readable medium described herein may further include operations, features, means, or instructions for receiving, via the modulated portion of the continuous RF waveform, an additional report message indicating an input power level.

In some examples of the method, apparatuses, and non-transitory computer-readable medium described herein, the one or more parameters associated with the reference signal may be based on a memory capability of the second wireless device.

In some examples of the method, apparatuses, and non-transitory computer-readable medium described herein, a memory of the second wireless device may be associated with the capability of the second wireless device in a current communication period, a previous communication period, or both.

### BRIEF DESCRIPTION OF THE DRAWINGS

FIGS. 1 and 2 illustrate examples of a wireless communications system that supports reference signal design for passive wireless devices in accordance with one or more aspects of the present disclosure.

FIG. 3 illustrates an example of a resource diagram that supports reference signal design for passive wireless devices in accordance with one or more aspects of the present disclosure.

FIG. 4 illustrates an example of a process flow that supports reference signal design for passive wireless devices in accordance with one or more aspects of the present disclosure.

FIGS. 5 and 6 show block diagrams of devices that support reference signal design for passive wireless devices in accordance with one or more aspects of the present disclosure.

FIG. 7 shows a block diagram of a communications manager that supports reference signal design for passive wireless devices in accordance with one or more aspects of the present disclosure.

FIG. 8 shows a diagram of a system including a device that supports reference signal design for passive wireless devices in accordance with one or more aspects of the present disclosure.

FIGS. 9 through 14 show flowcharts illustrating methods that support reference signal design for passive wireless devices in accordance with one or more aspects of the present disclosure.

### DETAILED DESCRIPTION

Some wireless communications systems (e.g., ultra-high frequency (UHF) radio frequency identification (RFID) systems) may include devices that use backscatter communication techniques. Backscatter communication techniques may enable one or more devices to communicate without active radio frequency (RF) components. For example, backscatter communication may enable an RFID device (e.g., a passive RFID tag, a semi-passive RFID tag, or both) that excludes an internal power source (e.g., battery), or has a limited power supply, to communicate with other devices (e.g., which may be referred to as a reading device, a scanning device, or the like). The RFID device may harvest energy from signals (e.g., electromagnetic waves) that are received over the air to power circuitry used for demodulating signals and for transmitting information in response to a received command. In some examples, the RFID device may not be configured to perform reference signal measurements, reference signal transmissions, or both. Accordingly, a source device may be unable to perform beamforming or decoding of signals from the RFID device.

As described herein, a wireless device (e.g., a user equipment (UE), network entity, network node, network unit, integrated access and backhaul (LAB) relay, relay, radio access network (RAN) node, or any other active wireless device) may send one or more parameters to an RFID device, such that the RFID device may perform one or more reference signal measurements, reference signal transmissions, or both. For example, the RFID device may use the parameters to perform one or more channel state information (CSI) measurements and may subsequently send a CSI report to the wireless device. Additionally, or alternatively, the RFID device may use the parameters to backscatter a sounding reference signal (SRS) to the wireless device. In some cases, the parameters may be based on a capability of the RFID device to send the CSI report or the SRS transmission, a device class of the RFID device, or both. In some examples, a control node may select the parameters and send an indication of the parameters to the wireless device, which may be used by the wireless device to perform CSI measurements, send a CSI report, or send an SRS.

Aspects of the disclosure are initially described in the context of wireless communications systems. Aspects of the disclosure are further described in the context of resource diagrams and process flows. Aspects of the disclosure are further illustrated by and described with reference to apparatus diagrams, system diagrams, and flowcharts that relate to reference signal design for passive wireless devices.

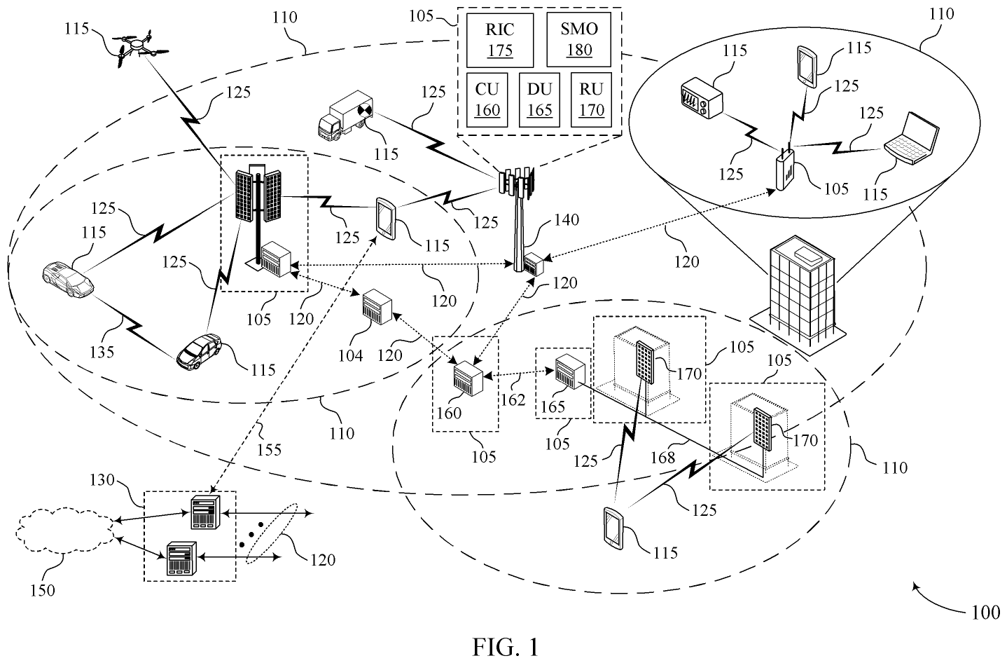

FIG. 1 illustrates an example of a wireless communications system 100 that supports reference signal design for passive wireless devices in accordance with one or more aspects of the present disclosure. The wireless communications system 100 may include one or more network entities 105, one or more UEs 115, and a core network 130. In some examples, the wireless communications system 100 may be a Long Term Evolution (LTE) network, an LTE-Advanced (LTE-A) network, an LTE-A Pro network, a New Radio (NR) network, or a network operating in accordance with other systems and radio technologies, including future systems and radio technologies not explicitly mentioned herein.

The network entities 105 may be dispersed throughout a geographic area to form the wireless communications system 100 and may include devices in different forms or having different capabilities. In various examples, a network entity 105 may be referred to as a network element, a mobility element, a RAN node, or network equipment, among other nomenclature. In some examples, network entities 105 and UEs 115 may wirelessly communicate via one or more communication links 125 (e.g., a RF access link). For example, a network entity 105 may support a coverage area 110 (e.g., a geographic coverage area) over which the UEs 115 and the network entity 105 may establish one or more communication links 125. The coverage area 110 may be an example of a geographic area over which a network entity 105 and a UE 115 may support the communication of signals according to one or more radio access technologies (RATs).

The UEs 115 may be dispersed throughout a coverage area 110 of the wireless communications system 100, and each UE 115 may be stationary, or mobile, or both at different times. The UEs 115 may be devices in different forms or having different capabilities. Some example UEs 115 are illustrated in FIG. 1. The UEs 115 described herein may be capable of supporting communications with various types of devices, such as other UEs 115 or network entities 105, as shown in FIG. 1.

As described herein, a node of the wireless communications system 100, which may be referred to as a network node, or a wireless node, may be a network entity 105 (e.g., any network entity described herein), a UE 115 (e.g., any UE described herein), a network controller, an apparatus, a device, a computing system, one or more components, or another suitable processing entity configured to perform any of the techniques described herein. For example, a node may be a UE 115. As another example, a node may be a network entity 105. As another example, a first node may be configured to communicate with a second node or a third node. In one aspect of this example, the first node may be a UE 115, the second node may be a network entity 105, and the third node may be a UE 115. In another aspect of this example, the first node may be a UE 115, the second node may be a network entity 105, and the third node may be a network entity 105. In yet other aspects of this example, the first, second, and third nodes may be different relative to these examples. Similarly, reference to a UE 115, network entity 105, apparatus, device, or computing system may include disclosure of the UE 115, network entity 105, apparatus, device, or computing system being a node. For example, disclosure that a UE 115 is configured to receive information from a network entity 105 also discloses that a first node is configured to receive information from a second node.

In some examples, network entities 105 may communicate with the core network 130, or with one another, or both. For example, network entities 105 may communicate with the core network 130 via one or more backhaul communication links 120 (e.g., in accordance with an S1, N2, N3, or another interface protocol). In some examples, network entities 105 may communicate with one another via a backhaul communication link 120 (e.g., in accordance with an X2, Xn, or other interface protocol) either directly (e.g., directly between network entities 105) or indirectly (e.g., via a core network 130). In some examples, network entities 105 may communicate with one another via a midhaul communication link 162 (e.g., in accordance with a midhaul interface protocol) or a fronthaul communication link 168 (e.g., in accordance with a fronthaul interface protocol), or any combination thereof. The backhaul communication links 120, midhaul communication links 162, or fronthaul communication links 168 may be or include one or more wired links (e.g., an electrical link, an optical fiber link), one or more wireless links (e.g., a radio link, a wireless optical link), among other examples or various combinations thereof. A UE 115 may communicate with the core network 130 via a communication link 155.

One or more of the network entities 105 described herein may include or may be referred to as a base station 140 (e.g., a base transceiver station, a radio base station, an NR base station, an access point, a radio transceiver, a NodeB, an eNodeB (eNB), a next-generation NodeB or a giga-NodeB (either of which may be referred to as a gNB), a 5G NB, a next-generation eNB (ng-eNB), a Home NodeB, a Home eNodeB, or other suitable terminology). In some examples, a network entity 105 (e.g., a base station 140) may be implemented in an aggregated (e.g., monolithic, standalone) base station architecture, which may be configured to utilize a protocol stack that is physically or logically integrated within a single network entity 105 (e.g., a single RAN node, such as a base station 140).

In some examples, a network entity 105 may be implemented in a disaggregated architecture (e.g., a disaggregated base station architecture, a disaggregated RAN architecture), which may be configured to utilize a protocol stack that is physically or logically distributed among two or more network entities 105, such as an integrated access backhaul (IAB) network, an open RAN (O-RAN) (e.g., a network configuration sponsored by the O-RAN Alliance), or a virtualized RAN (vRAN) (e.g., a cloud RAN (C-RAN)). For example, a network entity 105 may include one or more of a central unit (CU) 160, a distributed unit (DU) 165, a radio unit (RU) 170, a RAN Intelligent Controller (RIC) 175 (e.g., a Near-Real Time RIC (Near-RT RIC), a Non-Real Time RIC (Non-RT RIC)), a Service Management and Orchestration (SMO) 180 system, or any combination thereof. An RU 170 may also be referred to as a radio head, a smart radio head, a remote radio head (RRH), a remote radio unit (RRU), or a transmission reception point (TRP). One or more components of the network entities 105 in a disaggregated RAN architecture may be co-located, or one or more components of the network entities 105 may be in distributed locations (e.g., separate physical locations). In some examples, one or more network entities 105 of a disaggregated RAN architecture may be implemented as virtual units (e.g., a virtual CU (VCU), a virtual DU (VDU), a virtual RU (VRU)).

The split of functionality between a CU 160, a DU 165, and an RU 170 is flexible and may support different functionalities depending on which functions (e.g., network layer functions, protocol layer functions, baseband functions, RF functions, and any combinations thereof) are performed at a CU 160, a DU 165, or an RU 170. For example, a functional split of a protocol stack may be employed between a CU 160 and a DU 165 such that the CU 160 may support one or more layers of the protocol stack and the DU 165 may support one or more different layers of the protocol stack. In some examples, the CU 160 may host upper protocol layer (e.g., layer 3 (L3), layer 2 (L2)) functionality and signaling (e.g., Radio Resource Control (RRC), service data adaption protocol (SDAP), Packet Data Convergence Protocol (PDCP)). The CU 160 may be connected to one or more DUs 165 or RUs 170, and the one or more DUs 165 or RUs 170 may host lower protocol layers, such as layer 1 (L1) (e.g., physical (PHY) layer) or L2 (e.g., radio link control (RLC) layer, medium access control (MAC) layer) functionality and signaling and may each be at least partially controlled by the CU 160. Additionally, or alternatively, a functional split of the protocol stack may be employed between a DU 165 and an RU 170 such that the DU 165 may support one or more layers of the protocol stack and the RU 170 may support one or more different layers of the protocol stack. The DU 165 may support one or multiple different cells (e.g., via one or more RUs 170). In some cases, a functional split between a CU 160 and a DU 165, or between a DU 165 and an RU 170 may be within a protocol layer (e.g., some functions for a protocol layer may be performed by one of a CU 160, a DU 165, or an RU 170, while other functions of the protocol layer are performed by a different one of the CU 160, the DU 165, or the RU 170). A CU 160 may be functionally split further into CU control plane (CU-CP) and CU user plane (CU-UP) functions. A CU 160 may be connected to one or more DUs 165 via a midhaul communication link 162 (e.g., F1, F1-c, F1-u), and a DU 165 may be connected to one or more RUs 170 via a fronthaul communication link 168 (e.g., open fronthaul (FH) interface). In some examples, a midhaul communication link 162 or a fronthaul communication link 168 may be implemented in accordance with an interface (e.g., a channel) between layers of a protocol stack supported by respective network entities 105 that are in communication via such communication links.

In wireless communications systems (e.g., wireless communications system 100), infrastructure and spectral resources for radio access may support wireless backhaul link capabilities to supplement wired backhaul connections, providing an IAB network architecture (e.g., to a core network 130). In some cases, in an IAB network, one or more network entities 105 (e.g., IAB nodes 104) may be partially controlled by each other. One or more IAB nodes 104 may be referred to as a donor entity or an IAB donor. One or more DUs 165 or one or more RUs 170 may be partially controlled by one or more CUs 160 associated with a donor network entity 105 (e.g., a donor base station 140). The one or more donor network entities 105 (e.g., IAB donors) may be in communication with one or more additional network entities 105 (e.g., IAB nodes 104) via supported access and backhaul links (e.g., backhaul communication links 120). IAB nodes 104 may include an IAB mobile termination (IAB-MT) controlled (e.g., scheduled) by DUs 165 of a coupled IAB donor. An IAB-MT may include an independent set of antennas for relay of communications with UEs 115, or may share the same antennas (e.g., of an RU 170) of an IAB node 104 used for access via the DU 165 of the IAB node 104 (e.g., referred to as virtual IAB-MT (vIAB-MT)). In some examples, the IAB nodes 104 may include DUs 165 that support communication links with additional entities (e.g., IAB nodes 104, UEs 115) within the relay chain or configuration of the access network (e.g., downstream). In such cases, one or more components of the disaggregated RAN architecture (e.g., one or more IAB nodes 104 or components of IAB nodes 104) may be configured to operate according to the techniques described herein.

For instance, an access network (AN) or RAN may include communications between access nodes (e.g., an IAB donor), IAB nodes 104, and one or more UEs 115. The IAB donor may facilitate connection between the core network 130 and the AN (e.g., via a wired or wireless connection to the core network 130). That is, an IAB donor may refer to a RAN node with a wired or wireless connection to core network 130. The IAB donor may include a CU 160 and at least one DU 165 (e.g., and RU 170), in which case the CU 160 may communicate with the core network 130 via an interface (e.g., a backhaul link). IAB donor and IAB nodes 104 may communicate via an F1 interface according to a protocol that defines signaling messages (e.g., an F1 AP protocol). Additionally, or alternatively, the CU 160 may communicate with the core network via an interface, which may be an example of a portion of backhaul link, and may communicate with other CUs 160 (e.g., a CU 160 associated with an alternative IAB donor) via an Xn-C interface, which may be an example of a portion of a backhaul link.

An IAB node 104 may refer to a RAN node that provides IAB functionality (e.g., access for UEs 115, wireless self-backhauling capabilities). A DU 165 may act as a distributed scheduling node towards child nodes associated with the IAB node 104, and the IAB-MT may act as a scheduled node towards parent nodes associated with the IAB node 104. That is, an IAB donor may be referred to as a parent node in communication with one or more child nodes (e.g., an IAB donor may relay transmissions for UEs through one or more other IAB nodes 104). Additionally, or alternatively, an IAB node 104 may also be referred to as a parent node or a child node to other IAB nodes 104, depending on the relay chain or configuration of the AN. Therefore, the IAB-MT entity of TAB nodes 104 may provide a Uu interface for a child IAB node 104 to receive signaling from a parent IAB node 104, and the DU interface (e.g., DUs 165) may provide a Uu interface for a parent IAB node 104 to signal to a child IAB node 104 or UE 115.

For example, IAB node 104 may be referred to as a parent node that supports communications for a child IAB node or referred to as a child IAB node associated with an IAB donor, or both. The IAB donor may include a CU 160 with a wired or wireless connection (e.g., a backhaul communication link 120) to the core network 130 and may act as parent node to IAB nodes 104. For example, the DU 165 of IAB donor may relay transmissions to UEs 115 through IAB nodes 104, or may directly signal transmissions to a UE 115, or both. The CU 160 of IAB donor may signal communication link establishment via an F1 interface to IAB nodes 104, and the IAB nodes 104 may schedule transmissions (e.g., transmissions to the UEs 115 relayed from the IAB donor) through the DUs 165. That is, data may be relayed to and from IAB nodes 104 via signaling via an NR Uu interface to MT of the IAB node 104. Communications with IAB node 104 may be scheduled by a DU 165 of IAB donor and communications with IAB node 104 may be scheduled by DU 165 of IAB node 104.

In the case of the techniques described herein applied in the context of a disaggregated RAN architecture, one or more components of the disaggregated RAN architecture may be configured to support reference signal design for passive wireless devices as described herein. For example, some operations described as being performed by a UE 115 or a network entity 105 (e.g., a base station 140) may additionally, or alternatively, be performed by one or more components of the disaggregated RAN architecture (e.g., IAB nodes 104, DUs 165, CUs 160, RUs 170, RIC 175, SMO 180).

A UE 115 may include or may be referred to as a mobile device, a wireless device, a remote device, a handheld device, or a subscriber device, or some other suitable terminology, where the “device” may also be referred to as a unit, a station, a terminal, or a client, among other examples. A UE 115 may also include or may be referred to as a personal electronic device such as a cellular phone, a personal digital assistant (PDA), a multimedia/entertainment device (e.g., a radio, a MP3 player, or a video device), a camera, a gaming device, a navigation/positioning device (e.g., GNSS (global navigation satellite system) devices based on, for example, GPS (global positioning system), Beidou, GLONASS, or Galileo, or a terrestrial-based device), a tablet computer, a laptop computer, a personal computer, a netbook, a smartbook, a personal computer, a smart device, a wearable device (e.g., a smart watch, smart clothing, smart glasses, virtual reality goggles, a smart wristband, smart jewelry (e.g., a smart ring, a smart bracelet)), a drone, a robot/robotic device, a vehicle, a vehicular device, a meter (e.g., parking meter, electric meter, gas meter, water meter), a monitor, a gas pump, an appliance (e.g., kitchen appliance, washing machine, dryer), a location tag, a medical/healthcare device, an implant, a sensor/actuator, a display, or any other suitable device configured to communicate via a wireless or wired medium. In some examples, a UE 115 may include or be referred to as a wireless local loop (WLL) station, an Internet of Things (IoT) device, an Internet of Everything (IoE) device, or a machine type communications (MTC) device, among other examples, which may be implemented in various objects such as appliances, or vehicles, meters, among other examples.

The UEs 115 described herein may be able to communicate with various types of devices, such as other UEs 115 that may sometimes act as relays as well as the network entities 105 and the network equipment including macro eNBs or gNBs, small cell eNBs or gNBs, or relay base stations, among other examples, as shown in FIG. 1.

The UEs 115 and the network entities 105 may wirelessly communicate with one another via one or more communication links 125 (e.g., an access link) using resources associated with one or more carriers. The term “carrier” may refer to a set of RF spectrum resources having a defined physical layer structure for supporting the communication links 125. For example, a carrier used for a communication link 125 may include a portion of a RF spectrum band (e.g., a bandwidth part (BWP)) that is operated according to one or more physical layer channels for a given radio access technology (e.g., LTE, LTE-A, LTE-A Pro, NR). Each physical layer channel may carry acquisition signaling (e.g., synchronization signals, system information), control signaling that coordinates operation for the carrier, user data, or other signaling. The wireless communications system 100 may support communication with a UE 115 using carrier aggregation or multi-carrier operation. A UE 115 may be configured with multiple downlink component carriers and one or more uplink component carriers according to a carrier aggregation configuration. Carrier aggregation may be used with both frequency division duplexing (FDD) and time division duplexing (TDD) component carriers. Communication between a network entity 105 and other devices may refer to communication between the devices and any portion (e.g., entity, sub-entity) of a network entity 105. For example, the terms “transmitting,” “receiving,” or “communicating,” when referring to a network entity 105, may refer to any portion of a network entity 105 (e.g., a base station 140, a CU 160, a DU 165, a RU 170) of a RAN communicating with another device (e.g., directly or via one or more other network entities 105).

In some examples, such as in a carrier aggregation configuration, a carrier may also have acquisition signaling or control signaling that coordinates operations for other carriers. A carrier may be associated with a frequency channel (e.g., an evolved universal mobile telecommunication system terrestrial radio access (E-UTRA) absolute RF channel number (EARFCN)) and may be identified according to a channel raster for discovery by the UEs 115. A carrier may be operated in a standalone mode, in which case initial acquisition and connection may be conducted by the UEs 115 via the carrier, or the carrier may be operated in a non-standalone mode, in which case a connection is anchored using a different carrier (e.g., of the same or a different radio access technology).

The communication links 125 shown in the wireless communications system 100 may include downlink transmissions (e.g., forward link transmissions) from a network entity 105 to a UE 115, uplink transmissions (e.g., return link transmissions) from a UE 115 to a network entity 105, or both, among other configurations of transmissions. Carriers may carry downlink or uplink communications (e.g., in an FDD mode) or may be configured to carry downlink and uplink communications (e.g., in a TDD mode).

A carrier may be associated with a particular bandwidth of the RF spectrum and, in some examples, the carrier bandwidth may be referred to as a “system bandwidth” of the carrier or the wireless communications system 100. For example, the carrier bandwidth may be one of a set of bandwidths for carriers of a particular radio access technology (e.g., 1.4, 3, 5, 10, 15, 20, 40, or 80 megahertz (MHz)). Devices of the wireless communications system 100 (e.g., the network entities 105, the UEs 115, or both) may have hardware configurations that support communications using a particular carrier bandwidth or may be configurable to support communications using one of a set of carrier bandwidths. In some examples, the wireless communications system 100 may include network entities 105 or UEs 115 that support concurrent communications using carriers associated with multiple carrier bandwidths. In some examples, each served UE 115 may be configured for operating using portions (e.g., a sub-band, a BWP) or all of a carrier bandwidth.

Signal waveforms transmitted via a carrier may be made up of multiple subcarriers (e.g., using multi-carrier modulation (MCM) techniques such as orthogonal frequency division multiplexing (OFDM) or discrete Fourier transform spread OFDM (DFT-S-OFDM)). In a system employing MCM techniques, a resource element may refer to resources of one symbol period (e.g., a duration of one modulation symbol) and one subcarrier, in which case the symbol period and subcarrier spacing may be inversely related. The quantity of bits carried by each resource element may depend on the modulation scheme (e.g., the order of the modulation scheme, the coding rate of the modulation scheme, or both), such that a relatively higher quantity of resource elements (e.g., in a transmission duration) and a relatively higher order of a modulation scheme may correspond to a relatively higher rate of communication. A wireless communications resource may refer to a combination of an RF spectrum resource, a time resource, and a spatial resource (e.g., a spatial layer, a beam), and the use of multiple spatial resources may increase the data rate or data integrity for communications with a UE 115.

One or more numerologies for a carrier may be supported, and a numerology may include a subcarrier spacing (Δf) and a cyclic prefix. A carrier may be divided into one or more BWPs having the same or different numerologies. In some examples, a UE 115 may be configured with multiple BWPs. In some examples, a single BWP for a carrier may be active at a given time and communications for the UE 115 may be restricted to one or more active BWPs.

The time intervals for the network entities 105 or the UEs 115 may be expressed in multiples of a basic time unit which may, for example, refer to a sampling period of Tₛ=1/(Δfₘₐₓ·N_{f}) seconds, for which Δfₘₐₓ may represent a supported subcarrier spacing, and N_{f} may represent a supported discrete Fourier transform (DFT) size. Time intervals of a communications resource may be organized according to radio frames each having a specified duration (e.g., 10 milliseconds (ms)). Each radio frame may be identified by a system frame number (SFN) (e.g., ranging from 0 to 1023).

Each frame may include multiple consecutively numbered subframes or slots, and each subframe or slot may have the same duration. In some examples, a frame may be divided (e.g., in the time domain) into subframes, and each subframe may be further divided into a quantity of slots. Alternatively, each frame may include a variable quantity of slots, and the quantity of slots may depend on subcarrier spacing. Each slot may include a quantity of symbol periods (e.g., depending on the length of the cyclic prefix prepended to each symbol period). In some wireless communications systems 100, a slot may further be divided into multiple mini-slots associated with one or more symbols. Excluding the cyclic prefix, each symbol period may be associated with one or more (e.g., N_{f}) sampling periods. The duration of a symbol period may depend on the subcarrier spacing or frequency band of operation.

A subframe, a slot, a mini-slot, or a symbol may be the smallest scheduling unit (e.g., in the time domain) of the wireless communications system 100 and may be referred to as a transmission time interval (TTI). In some examples, the TTI duration (e.g., a quantity of symbol periods in a TTI) may be variable. Additionally, or alternatively, the smallest scheduling unit of the wireless communications system 100 may be dynamically selected (e.g., in bursts of shortened TTIs (sTTIs)).

Physical channels may be multiplexed for communication using a carrier according to various techniques. A physical control channel and a physical data channel may be multiplexed for signaling via a downlink carrier, for example, using one or more of time division multiplexing (TDM) techniques, frequency division multiplexing (FDM) techniques, or hybrid TDM-FDM techniques. A control region (e.g., a control resource set (CORESET)) for a physical control channel may be defined by a set of symbol periods and may extend across the system bandwidth or a subset of the system bandwidth of the carrier. One or more control regions (e.g., CORESETs) may be configured for a set of the UEs 115. For example, one or more of the UEs 115 may monitor or search control regions for control information according to one or more search space sets, and each search space set may include one or multiple control channel candidates in one or more aggregation levels arranged in a cascaded manner. An aggregation level for a control channel candidate may refer to an amount of control channel resources (e.g., control channel elements (CCEs)) associated with encoded information for a control information format having a given payload size. Search space sets may include common search space sets configured for sending control information to multiple UEs 115 and UE-specific search space sets for sending control information to a specific UE 115.

A network entity 105 may provide communication coverage via one or more cells, for example a macro cell, a small cell, a hot spot, or other types of cells, or any combination thereof. The term “cell” may refer to a logical communication entity used for communication with a network entity 105 (e.g., using a carrier) and may be associated with an identifier for distinguishing neighboring cells (e.g., a physical cell identifier (PCID), a virtual cell identifier (VCID), or others). In some examples, a cell also may refer to a coverage area 110 or a portion of a coverage area 110 (e.g., a sector) over which the logical communication entity operates. Such cells may range from smaller areas (e.g., a structure, a subset of structure) to larger areas depending on various factors such as the capabilities of the network entity 105. For example, a cell may be or include a building, a subset of a building, or exterior spaces between or overlapping with coverage areas 110, among other examples.

A macro cell generally covers a relatively large geographic area (e.g., several kilometers in radius) and may allow unrestricted access by the UEs 115 with service subscriptions with the network provider supporting the macro cell. A small cell may be associated with a lower-powered network entity 105 (e.g., a lower-powered base station 140), as compared with a macro cell, and a small cell may operate using the same or different (e.g., licensed, unlicensed) frequency bands as macro cells. Small cells may provide unrestricted access to the UEs 115 with service subscriptions with the network provider or may provide restricted access to the UEs 115 having an association with the small cell (e.g., the UEs 115 in a closed subscriber group (CSG), the UEs 115 associated with users in a home or office). A network entity 105 may support one or multiple cells and may also support communications via the one or more cells using one or multiple component carriers.

In some examples, a carrier may support multiple cells, and different cells may be configured according to different protocol types (e.g., MTC, narrowband IoT (NB-IoT), enhanced mobile broadband (eMBB)) that may provide access for different types of devices.

In some examples, a network entity 105 (e.g., a base station 140, an RU 170) may be movable and therefore provide communication coverage for a moving coverage area 110. In some examples, different coverage areas 110 associated with different technologies may overlap, but the different coverage areas 110 may be supported by the same network entity 105. In some other examples, the overlapping coverage areas 110 associated with different technologies may be supported by different network entities 105. The wireless communications system 100 may include, for example, a heterogeneous network in which different types of the network entities 105 provide coverage for various coverage areas 110 using the same or different radio access technologies.

The wireless communications system 100 may support synchronous or asynchronous operation. For synchronous operation, network entities 105 (e.g., base stations 140) may have similar frame timings, and transmissions from different network entities 105 may be approximately aligned in time. For asynchronous operation, network entities 105 may have different frame timings, and transmissions from different network entities 105 may, in some examples, not be aligned in time. The techniques described herein may be used for either synchronous or asynchronous operations.

Some UEs 115, such as MTC or IoT devices, may be low cost or low complexity devices and may provide for automated communication between machines (e.g., via Machine-to-Machine (M2M) communication). M2M communication or MTC may refer to data communication technologies that allow devices to communicate with one another or a network entity 105 (e.g., a base station 140) without human intervention. In some examples, M2M communication or MTC may include communications from devices that integrate sensors or meters to measure or capture information and relay such information to a central server or application program that uses the information or presents the information to humans interacting with the application program. Some UEs 115 may be designed to collect information or enable automated behavior of machines or other devices. Examples of applications for MTC devices include smart metering, inventory monitoring, water level monitoring, equipment monitoring, healthcare monitoring, wildlife monitoring, weather and geological event monitoring, fleet management and tracking, remote security sensing, physical access control, and transaction-based business charging. In an aspect, techniques disclosed herein may be applicable to MTC or IoT UEs. MTC or IoT UEs may include MTC/enhanced MTC (eMTC, also referred to as CAT-M, Cat M1) UEs, NB-IoT (also referred to as CAT NB1) UEs, as well as other types of UEs. eMTC and NB-IoT may refer to future technologies that may evolve from or may be based on these technologies. For example, eMTC may include FeMTC (further eMTC), eFeMTC (enhanced further eMTC), and mMTC (massive MTC), and NB-IoT may include eNB-IoT (enhanced NB-IoT), and FeNB-IoT (further enhanced NB-IoT).

Some UEs 115 may be configured to employ operating modes that reduce power consumption, such as half-duplex communications (e.g., a mode that supports one-way communication via transmission or reception, but not transmission and reception concurrently). In some examples, half-duplex communications may be performed at a reduced peak rate. Other power conservation techniques for the UEs 115 include entering a power saving deep sleep mode when not engaging in active communications, operating using a limited bandwidth (e.g., according to narrowband communications), or a combination of these techniques. For example, some UEs 115 may be configured for operation using a narrowband protocol type that is associated with a defined portion or range (e.g., set of subcarriers or resource blocks (RBs)) within a carrier, within a guard-band of a carrier, or outside of a carrier.

The wireless communications system 100 may be configured to support ultra-reliable communications or low-latency communications, or various combinations thereof. For example, the wireless communications system 100 may be configured to support ultra-reliable low-latency communications (URLLC). The UEs 115 may be designed to support ultra-reliable, low-latency, or critical functions. Ultra-reliable communications may include private communication or group communication and may be supported by one or more services such as push-to-talk, video, or data. Support for ultra-reliable, low-latency functions may include prioritization of services, and such services may be used for public safety or general commercial applications. The terms ultra-reliable, low-latency, and ultra-reliable low-latency may be used interchangeably herein.

In some examples, a UE 115 may be configured to support communicating directly with other UEs 115 via a device-to-device (D2D) communication link 135 (e.g., in accordance with a peer-to-peer (P2P), D2D, or sidelink protocol). In some examples, one or more UEs 115 of a group that are performing D2D communications may be within the coverage area 110 of a network entity 105 (e.g., a base station 140, an RU 170), which may support aspects of such D2D communications being configured by (e.g., scheduled by) the network entity 105. In some examples, one or more UEs 115 of such a group may be outside the coverage area 110 of a network entity 105 or may be otherwise unable to or not configured to receive transmissions from a network entity 105. In some examples, groups of the UEs 115 communicating via D2D communications may support a one-to-many (1:M) system in which each UE 115 transmits to each of the other UEs 115 in the group. In some examples, a network entity 105 may facilitate the scheduling of resources for D2D communications. In some other examples, D2D communications may be carried out between the UEs 115 without an involvement of a network entity 105.

In some systems, a D2D communication link 135 may be an example of a communication channel, such as a sidelink communication channel, between vehicles (e.g., UEs 115). In some examples, vehicles may communicate using vehicle-to-everything (V2X) communications, vehicle-to-vehicle (V2V) communications, or some combination of these. A vehicle may signal information related to traffic conditions, signal scheduling, weather, safety, emergencies, or any other information relevant to a V2X system. In some examples, vehicles in a V2X system may communicate with roadside infrastructure, such as roadside units, or with the network via one or more network nodes (e.g., network entities 105, base stations 140, RUs 170) using vehicle-to-network (V2N) communications, or with both.

The core network 130 may provide user authentication, access authorization, tracking, Internet Protocol (IP) connectivity, and other access, routing, or mobility functions. The core network 130 may be an evolved packet core (EPC) or 5G core (5GC), which may include at least one control plane entity that manages access and mobility (e.g., a mobility management entity (MME), an access and mobility management function (AMF)) and at least one user plane entity that routes packets or interconnects to external networks (e.g., a serving gateway (S-GW), a Packet Data Network (PDN) gateway (P-GW), or a user plane function (UPF)). The control plane entity may manage non-access stratum (NAS) functions such as mobility, authentication, and bearer management for the UEs 115 served by the network entities 105 (e.g., base stations 140) associated with the core network 130. User IP packets may be transferred through the user plane entity, which may provide IP address allocation as well as other functions. The user plane entity may be connected to IP services 150 for one or more network operators. The IP services 150 may include access to the Internet, Intranet(s), an IP Multimedia Subsystem (IMS), or a Packet-Switched Streaming Service.

The wireless communications system 100 may operate using one or more frequency bands, which may be in the range of 300 megahertz (MHz) to 300 gigahertz (GHz). Generally, the region from 300 MHz to 3 GHz is known as the ultra-high frequency (UHF) region or decimeter band because the wavelengths range from approximately one decimeter to one meter in length. UHF waves may be blocked or redirected by buildings and environmental features, which may be referred to as clusters, but the waves may penetrate structures sufficiently for a macro cell to provide service to the UEs 115 located indoors. Communications using UHF waves may be associated with smaller antennas and shorter ranges (e.g., less than 100 kilometers) compared to communications using the smaller frequencies and longer waves of the high frequency (HF) or very high frequency (VHF) portion of the spectrum below 300 MHz.

The wireless communications system 100 may also operate using a super high frequency (SHF) region, which may be in the range of 3 GHz to 30 GHz, also known as the centimeter band, or using an extremely high frequency (EHF) region of the spectrum (e.g., from 30 GHz to 300 GHz), also known as the millimeter band. In some examples, the wireless communications system 100 may support millimeter wave (mmW) communications between the UEs 115 and the network entities 105 (e.g., base stations 140, RUs 170), and EHF antennas of the respective devices may be smaller and more closely spaced than UHF antennas. In some examples, such techniques may facilitate using antenna arrays within a device. The propagation of EHF transmissions, however, may be subject to even greater attenuation and shorter range than SHF or UHF transmissions. The techniques disclosed herein may be employed across transmissions that use one or more different frequency regions, and designated use of bands across these frequency regions may differ by country or regulating body.

The wireless communications system 100 may utilize both licensed and unlicensed RF spectrum bands. For example, the wireless communications system 100 may employ License Assisted Access (LAA), LTE-Unlicensed (LTE-U) radio access technology, or NR technology using an unlicensed band such as the 5 GHz industrial, scientific, and medical (ISM) band. While operating using unlicensed RF spectrum bands, devices such as the network entities 105 and the UEs 115 may employ carrier sensing for collision detection and avoidance. In some examples, operations using unlicensed bands may be based on a carrier aggregation configuration in conjunction with component carriers operating using a licensed band (e.g., LAA). Operations using unlicensed spectrum may include downlink transmissions, uplink transmissions, P2P transmissions, or D2D transmissions, among other examples.

A network entity 105 (e.g., a base station 140, an RU 170) or a UE 115 may be equipped with multiple antennas, which may be used to employ techniques such as transmit diversity, receive diversity, multiple-input multiple-output (MIMO) communications, or beamforming. The antennas of a network entity 105 or a UE 115 may be located within one or more antenna arrays or antenna panels, which may support MIMO operations or transmit or receive beamforming. For example, one or more base station antennas or antenna arrays may be co-located at an antenna assembly, such as an antenna tower. In some examples, antennas or antenna arrays associated with a network entity 105 may be located at diverse geographic locations. A network entity 105 may include an antenna array with a set of rows and columns of antenna ports that the network entity 105 may use to support beamforming of communications with a UE 115. Likewise, a UE 115 may include one or more antenna arrays that may support various MIMO or beamforming operations. Additionally, or alternatively, an antenna panel may support RF beamforming for a signal transmitted via an antenna port.

The network entities 105 or the UEs 115 may use MIMO communications to exploit multipath signal propagation and increase spectral efficiency by transmitting or receiving multiple signals via different spatial layers. Such techniques may be referred to as spatial multiplexing. The multiple signals may, for example, be transmitted by the transmitting device via different antennas or different combinations of antennas. Likewise, the multiple signals may be received by the receiving device via different antennas or different combinations of antennas. Each of the multiple signals may be referred to as a separate spatial stream and may carry information associated with the same data stream (e.g., the same codeword) or different data streams (e.g., different codewords). Different spatial layers may be associated with different antenna ports used for channel measurement and reporting. MIMO techniques include single-user MIMO (SU-MIMO), for which multiple spatial layers are transmitted to the same receiving device, and multiple-user MIMO (MU-MIMO), for which multiple spatial layers are transmitted to multiple devices.

Beamforming, which may also be referred to as spatial filtering, directional transmission, or directional reception, is a signal processing technique that may be used at a transmitting device or a receiving device (e.g., a network entity 105, a UE 115) to shape or steer an antenna beam (e.g., a transmit beam, a receive beam) along a spatial path between the transmitting device and the receiving device. Beamforming may be achieved by combining the signals communicated via antenna elements of an antenna array such that some signals propagating along particular orientations with respect to an antenna array experience constructive interference while others experience destructive interference. The adjustment of signals communicated via the antenna elements may include a transmitting device or a receiving device applying amplitude offsets, phase offsets, or both to signals carried via the antenna elements associated with the device. The adjustments associated with each of the antenna elements may be defined by a beamforming weight set associated with a particular orientation (e.g., with respect to the antenna array of the transmitting device or receiving device, or with respect to some other orientation).

A network entity 105 or a UE 115 may use beam sweeping techniques as part of beamforming operations. For example, a network entity 105 (e.g., a base station 140, an RU 170) may use multiple antennas or antenna arrays (e.g., antenna panels) to conduct beamforming operations for directional communications with a UE 115. Some signals (e.g., synchronization signals, reference signals, beam selection signals, or other control signals) may be transmitted by a network entity 105 multiple times along different directions. For example, the network entity 105 may transmit a signal according to different beamforming weight sets associated with different directions of transmission. Transmissions along different beam directions may be used to identify (e.g., by a transmitting device, such as a network entity 105, or by a receiving device, such as a UE 115) a beam direction for later transmission or reception by the network entity 105.

Some signals, such as data signals associated with a particular receiving device, may be transmitted by transmitting device (e.g., a transmitting network entity 105, a transmitting UE 115) along a single beam direction (e.g., a direction associated with the receiving device, such as a receiving network entity 105 or a receiving UE 115). In some examples, the beam direction associated with transmissions along a single beam direction may be determined based on a signal that was transmitted along one or more beam directions. For example, a UE 115 may receive one or more of the signals transmitted by the network entity 105 along different directions and may report to the network entity 105 an indication of the signal that the UE 115 received with a highest signal quality or an otherwise acceptable signal quality.

In some examples, transmissions by a device (e.g., by a network entity 105 or a UE 115) may be performed using multiple beam directions, and the device may use a combination of digital precoding or beamforming to generate a combined beam for transmission (e.g., from a network entity 105 to a UE 115). The UE 115 may report feedback that indicates precoding weights for one or more beam directions, and the feedback may correspond to a configured set of beams across a system bandwidth or one or more sub-bands. The network entity 105 may transmit a reference signal (e.g., a cell-specific reference signal (CRS), a CSI reference signal (CSI-RS)), which may be precoded or unprecoded. The UE 115 may provide feedback for beam selection, which may be a precoding matrix indicator (PMI) or codebook-based feedback (e.g., a multi-panel type codebook, a linear combination type codebook, a port selection type codebook). Although these techniques are described with reference to signals transmitted along one or more directions by a network entity 105 (e.g., a base station 140, an RU 170), a UE 115 may employ similar techniques for transmitting signals multiple times along different directions (e.g., for identifying a beam direction for subsequent transmission or reception by the UE 115) or for transmitting a signal along a single direction (e.g., for transmitting data to a receiving device).

A receiving device (e.g., a UE 115) may perform reception operations in accordance with multiple receive configurations (e.g., directional listening) when receiving various signals from a receiving device (e.g., a network entity 105), such as synchronization signals, reference signals, beam selection signals, or other control signals. For example, a receiving device may perform reception in accordance with multiple receive directions by receiving via different antenna subarrays, by processing received signals according to different antenna subarrays, by receiving according to different receive beamforming weight sets (e.g., different directional listening weight sets) applied to signals received at multiple antenna elements of an antenna array, or by processing received signals according to different receive beamforming weight sets applied to signals received at multiple antenna elements of an antenna array, any of which may be referred to as “listening” according to different receive configurations or receive directions. In some examples, a receiving device may use a single receive configuration to receive along a single beam direction (e.g., when receiving a data signal). The single receive configuration may be aligned along a beam direction determined based on listening according to different receive configuration directions (e.g., a beam direction determined to have a highest signal strength, highest signal-to-noise ratio (SNR), or otherwise acceptable signal quality based on listening according to multiple beam directions).

The wireless communications system 100 may be a packet-based network that operates according to a layered protocol stack. In the user plane, communications at the bearer or PDCP layer may be IP-based. An RLC layer may perform packet segmentation and reassembly to communicate via logical channels. A MAC layer may perform priority handling and multiplexing of logical channels into transport channels. The MAC layer also may implement error detection techniques, error correction techniques, or both to support retransmissions to improve link efficiency. In the control plane, an RRC layer may provide establishment, configuration, and maintenance of an RRC connection between a UE 115 and a network entity 105 or a core network 130 supporting radio bearers for user plane data. A PHY layer may map transport channels to physical channels.

The UEs 115 and the network entities 105 may support retransmissions of data to increase the likelihood that data is received successfully. Hybrid automatic repeat request (HARQ) feedback is one technique for increasing the likelihood that data is received correctly via a communication link (e.g., a communication link 125, a D2D communication link 135). HARQ may include a combination of error detection (e.g., using a cyclic redundancy check (CRC)), forward error correction (FEC), and retransmission (e.g., automatic repeat request (ARQ)). HARQ may improve throughput at the MAC layer in poor radio conditions (e.g., low signal-to-noise conditions). In some examples, a device may support same-slot HARQ feedback, in which case the device may provide HARQ feedback in a specific slot for data received via a previous symbol in the slot. In some other examples, the device may provide HARQ feedback in a subsequent slot, or according to some other time interval.

The wireless communications system 100 may include devices that use backscatter communication techniques. Backscatter communication techniques may enable one or more devices to communicate without active RF components. For example, backscatter communication may enable a UE 115 such as an RFID device (e.g., a passive RFID tag, a semi-passive RFID tag, or both) that may not include an internal power source (e.g., battery), or has a limited power supply, to communicate with other devices (e.g., which may be referred to as a source device, reading device, a scanning device, or the like). The RFID device may harvest energy from signals (e.g., electromagnetic waves) that are received over the air to power circuitry used for demodulating signals and for transmitting information in response to a received command. In some examples, the RFID device may not be configured to perform reference signal measurements, reference signal transmissions, or both. Accordingly, a source device may have difficulty beamforming or decoding signals to the RFID device.

As described herein, a wireless device (e.g., a UE 115, network entity 105, network node, network unit, IAB relay, relay, RAN node, or any other active wireless device) may send one or more parameters to an RFID device (e.g., UE 115), such that the RFID device may perform one or more reference signal measurements, reference signal transmissions, or both. For example, the RFID device may use the parameters to perform one or more CSI measurements, and may subsequently send a CSI report to the wireless device. Additionally, or alternatively, the RFID device may use the parameters to backscatter an SRS to the wireless device. In some cases, the parameters may be based on a capability of the RFID device to perform the CSI report and/or the SRS transmission, a device class of the RFID device, or both. In some examples, a control node may select the parameters and send an indication to the wireless device.

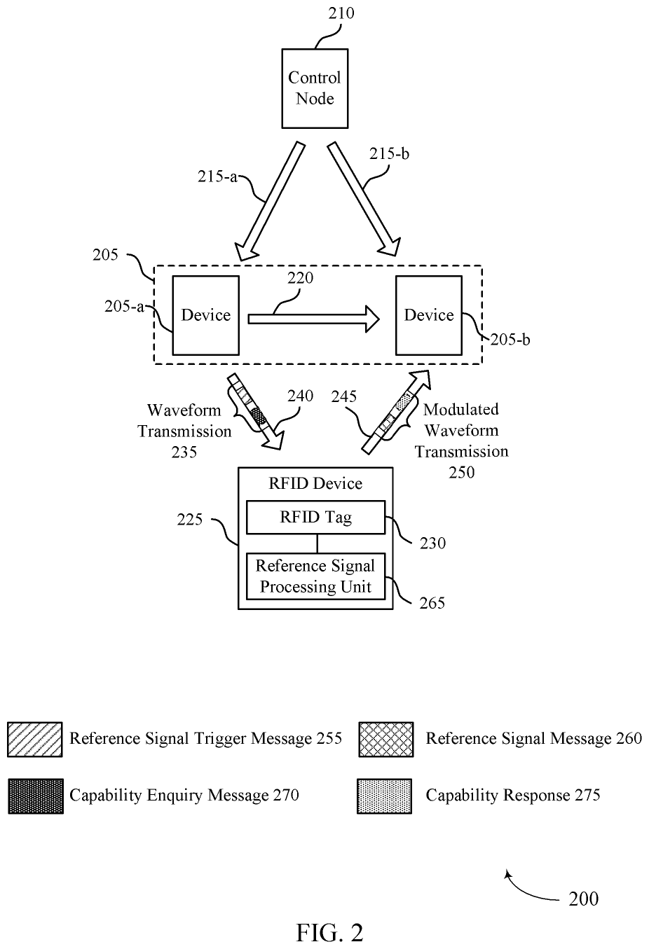

FIG. 2 illustrates an example of a wireless communications system 200 that supports reference signal design for passive wireless devices in accordance with one or more aspects of the present disclosure. In some examples, wireless communications system 200 may implement aspects of wireless communications system 100 and may include a wireless device 205-a and a wireless device 205-b, which may be examples of a UE 115, network entity 105, network node, network unit, IAB relay, relay, RAN node, or any other active wireless device, such as those described with reference to FIG. 1. Similarly, the wireless communications system 200 may include a control node 210, which may be an example of a network entity 105, a network node, a base station, or any other controlling wireless device, such as those described with reference to FIG. 1.

In some examples, the control node 210 may communicate control information, data, or both with the wireless device 205-a, the wireless device 205-b, or both using a downlink communication link 215-a, a downlink communication link 215-b, or both, respectively. Similarly, the wireless device 205-a may communicate data or control signaling with the wireless device 205-b via a communication link 220 (e.g., a sidelink communication link if the wireless device 205-a and the wireless device 205-b are UEs, or a downlink if the wireless device 205-a is a network entity and the wireless device 205-b is a UE). In some other examples, there may be a single wireless device, such as one of the wireless device 205-a or the wireless device 205-b, thus the wireless device 205-a and the wireless device 205-b may be referred to as one or more wireless devices 205.

In some examples, the one or more wireless devices 205 may include a single wireless device in a static mode of operation, where the RF source is the same device as or a component of the reader (e.g., the wireless device may have the capability to operate in a full-duplex mode, where transmitting and receiving occur concurrently). In some other examples, the one or more wireless devices 205 may include the wireless device 205-a and the wireless device 205-b in a bi-static mode of operation, where the RF source is a different device than the reader.

In the wireless communications system 200, the one or more wireless devices 205 may support RFID technology for identification, tracking, and similar use cases. For example, the one or more wireless devices 205 may communicate with one or more RFID devices, such as the RFID device 225, via a continuous RF waveform. The RFID device 225 may include an RFID tag 230, which includes an integrated circuit (IC), a rectifier, an energy storage unit, and an antenna, among other components, which may provide for the device to transmit data to a reader (e.g., the one or more wireless devices 205). In some cases, the rectifier may be an energy harvesting circuit with a diode and a capacitor that meet an energy conversion efficiency threshold (e.g., 30% energy conversion efficiency).

In some examples, the reader (e.g., the one or more wireless devices 205) may convert signaling into usable data from the RFID device 225. The RFID system may use signaling to activate RFID devices, where the RFID devices may not have a battery, or may have limited energy storage (e.g., capacitors). Additionally, or alliteratively, the RFID system may use the signaling for communications with the one or more wireless devices 205. For example, a wireless device 205-a may exchange, or transmit, a waveform transmission 235, which may be a continuous wave (CW) RF waveform transmission, using a forward link 240 and a backscatter link 245 (e.g., a backward link). The wireless device 205-a may send the waveform transmission 235 according to a known frequency, and the one or more wireless devices 205 (e.g., the wireless device 205-b) may receive a transmission from the RFID device 225 in response to the waveform transmission 235.

In some cases, communications from the one or more wireless devices 205 to the RFID device 225 (e.g., an RFID tag 230) may be referred to as forward link communications and may be sent via a forward link 240. The forward link communication may be used to power up the RFID device 225 (e.g., by sending one or more unmodulated or modulated signals to provide energy to the RFID device 225), convey commands or information via one or more modulated signals, and/or provide a backscatter link carrier wave via one or more unmodulated signals. In some other cases, the communication from the RFID device 225 to the one or more wireless devices 205 may be known as backscatter link communications or backward link communications and may be sent via a backscatter link 245. In some examples, the backscatter link 245 may use a backscatter communication technique that provides for a wireless device to communicate without active RF components. For example, the RFID device 225 may not have a power amplifier, a battery, or both, and the backscatter communication techniques may enable the RFID device 225 to harvest energy from a received signal (e.g., when the one or more wireless devices 205 are within a threshold distance, such as less than 10 meters (m)). The RFID device 225 may use the harvested energy to demodulate a received command and transmit modulated signaling in response. That is, the RFID device 225 may harvest energy from signals (e.g., the forward link communication) over the air to power an IC at the RFID tag 230.

In some cases, the wireless communications system 200 may include one or more RFID devices (e.g., zero-power devices), such as the RFID device 225, which may be a relatively lightweight IoT device that supports the backscatter communication techniques. The RFID device 225 may additionally, or alternatively, be referred to as a passive device, a passive internet of things (P-IOT) device, a zero-power IoT (ZP-IOT) device, semi-passive device, semi-active device, or active device. In some cases, passive devices may not use a power amplifier, a battery, or both while capturing power from the radio wave for performing transmissions. Semi-passive devices may include a battery (e.g., a rechargeable battery) and/or may be equipped with circuitry configured to harvest energy and store energy from one or more energy sources (e.g., RF signals). Semi-active devices may use active RF components such as a low noise amplifier (LNA), a power amplifier (PA), or both and may use a battery for transmissions. Active devices may use active RF components and generate waveforms or perform transmission techniques and may be classified as IoT devices, where the RF components may use active transmission techniques and may draw power from a battery. In some examples, the semi-active devices and active devices may be equipped with a transmitter, a receiver, a power source, or any combination thereof, which may provide for active transmission techniques. The semi-active devices and active devices may use the active transmission techniques to transmit and receive signals (e.g., transmissions, operations, broadcasts) to and from the one or more wireless devices 205. In some examples, the devices with passive properties (e.g., passive devices, semi-passive devices) may use the backscatter communication techniques for powering components configured to transmit signals in response to the one or more wireless devices 205 by harvested energy from signals.

The RFID device 225 (e.g., RFID tag(s)) may be, in some examples, a UE that uses an RFID tag radio at low power states, for one or more sleep modes, for one or more RRC states (e.g., during inactive, idle, connected, or any combination thereof), at one or more defined times based on an implementation (e.g., preference) at the RFID device 225 or an indication and/or agreement from a base station, or any combination thereof.

In some aspects, backscatter communication techniques may use an interrogator-talks-first (ITF) procedure between a reader (e.g., the one or more wireless devices 205) and the RFID device 225. The ITF procedure may involve a single waveform, which may define the structure and shape of information in transmitted signals. In some examples, the ITF procedure may use a continuous wave, which may be a sinusoidal wave that is modulated with an information-bearing signal to convey information. In some cases, the one or more wireless devices 205 may select a waveform to use to modulate the carrier wave.

In the ITF procedure, the one or more wireless devices 205, such as the wireless device 205-a, may transmit the waveform transmission 235 (e.g., a continuous RF wave transmission) to the RFID device 225, which may enable the RFID device 225 to collect energy from the continuous wave transmission. The collected energy at the RFID device 225 may reach some voltage (e.g., IC voltage on), at which point the RFID device 225 may turn on (e.g., power up an IC). In some cases, the waveform transmission 235 may be transmitted for some duration (e.g., greater than or equal to 400 microseconds (μs)) to power up the RFID device 225. After the duration, the one or more wireless devices 205 may transmit an information signal (e.g., including one or more commands) to the RFID device 225, where the information signal may also enable the RFID device 225 to harvest energy and remain active (e.g., powered on). The one or more commands may include instructions for the RFID device 225 to transmit some signaling or information requested by the one or more wireless devices 205. The one or more wireless devices 205 (e.g., a reader) may then transmit the continuous wave transmission to maintain the applied power (e.g., powered up) state of the RFID device 225 until the one or more wireless devices 205 receive a response to the one or more commands. In some aspects, the one or more wireless devices 205 may operate in a full-duplex communications mode to send the continuous wave transmission to maintain the power at the RFID device 225 while receiving signaling from the RFID device 225 in response to a command. In some cases, powering up the RFID device 225, maintaining the powered-up state of the RFID device 225, and transmitting the power and carrier wave for the tag modulation may use a same waveform.

In some examples, the one or more wireless devices 205, the RFID device 225, or both may modulate the waveform transmission 235, a modulated waveform transmission 250, or both according to an amplitude shift keying (ASK) modulation scheme. The ASK modulation may be a form of amplitude modulation representing digital data (e.g., 1s and 0s, steps, binary) as variations of amplitude in the carrier wave. In some examples, ASK modulation may represent the waveform as a series of bits being shifted repeatedly between high and low amplitudes. As such, the RFID systems may implement ASK modulation for forward link ASK and envelope detection, where a wireless device may use envelope detection to find amplitude variations of an incoming signal and to produce a control signal using the variations. As such, the one or more wireless devices 205 may use ASK modulation for the waveforms in backscatter communication to provide stable voltage and power in RF communication. For example, ASK modulation may involve square waveforms with digital on and off states, which show distinct time periods of steady communication. In some cases, the one or more wireless devices 205, the RFID device 225, or both may modulate the waveform transmission 235, the modulated waveform transmission 250, or both according to an ASK state and a defined modulation efficiency, where a first state may include an IC or antenna resistance match for backscatter power and a second state may include an IC or antenna resistance mismatch where there is no backscatter power.

In some examples, one or more parameters controlling a reflection at the RFID device 225 may indicate for the RFID device 225 to switch reflection off, such that the wireless device 205-b receives a direct link signal from the wireless device 205-a via the communication link 220. Additionally, or alternatively, the one or more parameters may indicate for the RFID device 225 to switch on reflection, such that the wireless device 205-b receives a superposition of both a direct link signal from the wireless device 205-a and a backscatter link signal from the RFID device 225.

In some examples, an RFID tag 230 may not perform CSI measurements or send SRS signals for RF sources or readers to estimate one or more communication channels. The lack of reference signal information from the CSI measurements or SRS signals may reduce accuracy and decoding of beamformed signals (e.g., from an RF source, such as the one or more wireless devices 205) to the RFID tag 230, as well as reducing the ability for the RFID tag 230 and the readers to decode transmissions. Thus, the one or more wireless devices may transmit (e.g., configure) an RFID device 225 with one or more parameters for measuring CSI or sending SRSs based on a capability of the RFID device 225.

In some examples, a wireless device 205-a may transmit a reference signal trigger message 255 in a waveform transmission 235 via a forward link 240 to an RFID device 225, such as once the RFID device 225 is activated from the energy harvesting techniques. The reference signal trigger message 255 may include one or more parameters for the RFID device 225 to use to perform CSI measurements or SRS transmissions, such as an order rank for port sounding, orthogonal resources in a time or frequency domain, antenna ports for data communication at the RFID device 225, or any combination thereof. The RFID device 225 may send a reference signal message 260 to the one or more wireless devices 205 (e.g., the wireless device 205-b), such as a CSI report or the SRS transmissions, in a portion of a modulated waveform transmission 250 via the backscatter link 245.

In some examples, the reference signal message 260 may be in accordance with a capability of the RFID device 225. For example, the RFID device 225 may have a capability to perform a CSI measurement, compute a CSI report, and prepare the CSI report. Additionally, or alternatively, the RFID device 225 may have a capability to transmit SRS signals. In some cases, the capability may depend on whether the RFID device is equipped with a reference signal processing unit 265. In some other cases, the capability may be based on a class of the RFID device 225, where each class may support different capabilities for CSI measurement and type of reporting. The class of the RFID device 225 may depend on a CSI configuration supported by the RFID device 225, a CSI configuration storage at the RFID device 225 (e.g., a capability to store a CSI reference signal configuration, how many CSI configurations the RFID device 225 may store, a current memory status of available memory, any other feature related to storage at the RFID device 225, or any combination thereof), a CSI reporting supported by the RFID device 225, an SRS configuration storage at the RFID device 225 (e.g., a capability to store an SRS configurations, how many SRS configurations the RFID device 225 may store, a current memory status of available memory, any other feature related to storage at the RFID device 225, or any combination thereof), a number of SRS transmissions supported by the RFID device 225, or any combination thereof.

In some examples, the one or more wireless devices 205, the control node 210, or both may transmit a capability enquiry message 270 to the RFID device 225, such as via the waveform transmission 235. The capability enquiry message 270 may include a request for the RFID device 225 to report a capability, such as a RFID device class, an indication of a reference signal processing unit 265, or any other CSI or SRS related capabilities of the RFID device 225. After receiving the capability enquiry message 270, or independent of the capability enquiry message 270 (e.g., after initial communication establishment), the RFID device may send a capability response 275 indicating the capabilities of the RFID device 225 to support the one or more CSI and/or SRS operations or procedures.

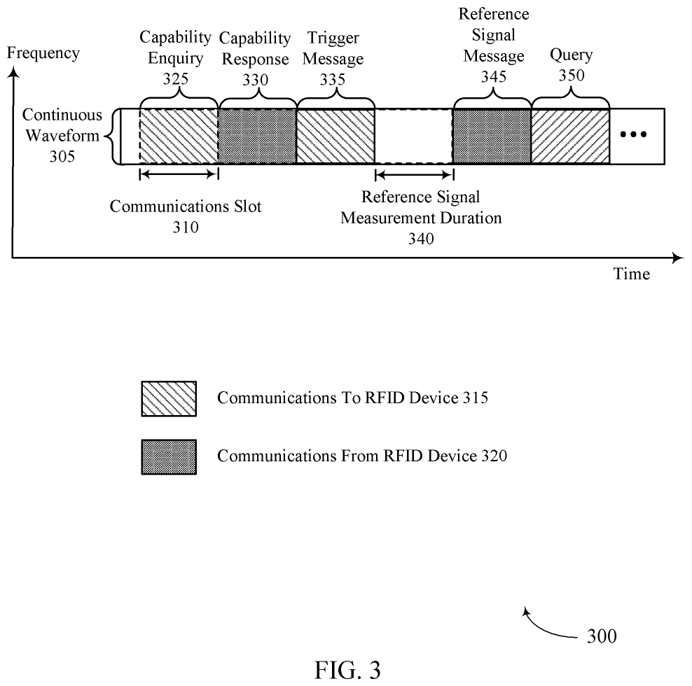

The RFID device 225 may use the waveform transmission 235 from the one or more wireless devices 205, such as the wireless device 205-a, to power up and measure the CSI-reference signal (CSI-RS), compute the CSI report, send the CSI-RS report, send SRS backscattered from the RFID device, or any combination thereof. That is, the RFID device 225 may perform the CSI-RS measurements and reporting as well as the SRS transmissions while the RF source (e.g., the wireless device 205-a) is transmitting the waveform transmission 235, such as for a same duration, which is described in further detail with respect to FIG. 3.

In some examples, one or more wireless devices 205 may scramble a CSI trigger or CSI configuration command with a scrambling code, scrambling sequence, a radio network temporary identifier (RNTI) dedicated for the RFID device 225 to perform the CSI procedures or operations. In some examples, the one or more wireless devices 205 may indicate one or more parameters for the CSI procedures or operations to the RFID device 225 in the reference signal trigger message 255, which may be referred to as a CSI report configuration. Additionally, or alternatively, the CSI report configuration may include one or more parameters related to SRS transmission, and may be referred to as an SRS configuration. In some cases, a wireless device 205-a of the one or more wireless devices 205 may select the parameters for the CSI report configuration. In some other cases, a control node 210 may select the parameters for the CSI report configuration and may indicate the parameters to the wireless device 205-a, the wireless device 205-b, or both such as in control signaling via the downlink communication link 215-a, the downlink communication link 215-b, or both, respectively.

In some examples, the one or more parameters in the CSI report configuration may include a sequence used by the wireless device 205-a, or the RF source, to send CSI-RS to the RFID device 225, where the indication of the sequence may be an index from a list of previously shared sequence, a sequence from a set of stored sequences (e.g., specified, loaded, preconfigured, or otherwise defined at the RFID device 225), or a sequence from a current communication session or a previous communication session that the RFID device has stored (e.g., the RFID device 225 may first check if the sequence is still stored). Additionally, or alternatively, the one or more parameters in the CSI report configuration may include CSI resources (e.g., a CSI-RS resource allocation of time-frequency resources), an indication of content to include in the CSI report (e.g., a precoding matrix indicator (PMI), a beam index among a set of beams used at the RF source, a beam sweep process, or any combination thereof), a charging rate at the RFID device 225 from the CSI-RS, an input power level to the RFID device 225, a pathloss measurement, reference signal received power (RSRP) measurement, reference signal received quality (RSRQ) measurement, or any combination thereof. The RF source, such as the one or more wireless devices 205, may use the input power level to compute and adjust the transmit power of the waveform transmission 235, or other transmissions from the one or more wireless devices 205 (e.g., to another wireless device).

In some cases, the one or more parameters in the CSI report configuration may include whether SRS transmissions are triggered or not (e.g., if the RFID device 225 is configured to sound one or more ports for backscattering and data reception purposes), a sequence the RFID device 225 is to use to transmit SRSs (e.g., to backscatter the waveform transmission 235 from the one or more wireless devices 205 with the SRS sequence), a sequence from a set of stored sequences for SRSs (e.g., specified, loaded, preconfigured, or otherwise defined at the RFID device 225), or a sequence for SRSs from a current communication session or a previous communication session that the RFID device 225 has stored (e.g., the RFID device 225 may first check if the sequence is still stored), or a time for the RFID device 225 to backscatter the CSI report to the one or more wireless devices 205 (e.g., the wireless device 205-b). In some cases, the wireless device 205-b may relay the information included in the reference signal message 260, which may include the CSI report, to the wireless device 205-a, the control node 210, or both. The wireless device 205-a, the control node 210, or both may adjust one or more transmission parameters in accordance with the information in the reference signal message 260.

In some examples, the amount of time the RFID device is powered up may be referred to as an ON duration. There may be multiple options for operations the RFID device 225 performs during the ON duration. For example, the RFID device 225 may harvest energy during the ON duration using an architecture where the RFID device 225 performs both data reception and energy harvesting at a same time (e.g., which may use two receivers), an architecture where the RFID device 225 splits the received signal into a stream for energy harvesting and a data stream, or an architecture where the RFID device 225 splits time between energy harvesting and data reception. In some other examples, the RFID device 225 may not harvest energy during the ON duration, and may instead use a battery to power the IC. In this example, the RFID device 225 may backscatter the incident signal.

In some cases, if the RFID device 225 has an advanced energy harvesting circuit, where the RFID device 225 may harvest energy then use the energy later such as by using a supercapacitor, the RFID device 225 may indicate the capacitor size to an RF source. The energy harvesting circuit may be qualified as advanced based on an ability of the RFID device 225 to maintain one or more energy units (e.g., Watts (W)) for a duration of time, such as a number of slots. The duration of time may depend on a subcarrier spacing (SCS) and a bandwidth of the wireless communications system 200, among other parameters. In some examples, the RFID device 225 may indicate the capacitor size to the one or more wireless devices 205 in the capability response 275. The one or more wireless devices 205 may determine a charging time of the RFID device 225 in accordance with the reported capacitor size.

Additionally, or alternatively, the RFID device 225 may include a RFID device class in the capability response 275, such that the one or more wireless devices 205 may know the supercapacitor size, where each class may have a respective supercapacitor size. In some cases, the class of the RFID device 225 may indicate multiple supercapacitor sizes, and the RFID device 225 may select a size based on a hardware implementation at the RFID device 225. Similarly, the RFID device 225 may indicate in the capability response 275 if the RFID device 225 has a power splitting circuit and has the ability to store at least a portion of the input power, a power splitting factor if the RFID device 225 splits the input power, an indication that the RFID device 225 has the ability to control the power splitting factor and what values the RFID device 225 has the ability to use for the power splitting factor, an indication of whether to perform power splitting on reading (e.g., backscattering the waveform transmission 235 during receiving, such as when the one or more wireless devices 205 are writing to the RFID device 225 or sending information or configurations to the RFID device), an indication of whether to perform power splitting writing, an indication of whether to perform power splitting on reading and writing, a power splitting factor for each case (e.g., the RFID device 225 may send using a different power value for each case), a time to achieve a full energy capacity (e.g., if the RFID device 225 stores some energy from an ongoing transmission), a time to start communication, a time to perform backscattering, a data rate (e.g., for receiving data), or any combination thereof. If the one or more wireless devices 205 send the waveform transmission 235 with a power greater than a threshold number of decibels per minute (dBm) (e.g., −25 dBm) at the RFID device 225, the one or more wireless devices 205 may indicate to the RFID device 225 to adjust a power splitter according to the power.

In some cases, the control node 210, or another device (e.g., the wireless device 205-a), may indicate one or more CSI-RS resources to the one or more wireless devices 205 and/or the RFID device 225 (e.g., an RF reader, the wireless device 205-b), the CSI-RS resources used to estimate the channel between one or more RF sources, such as the one or more wireless devices 205, and the RFID device 225. Additionally, or alternatively, the control node 210, or another device, may indicate one or more RF resources to the one or more wireless devices 205 or the RFID device 225, the RF resources used to determine a charging rate (e.g., RF energy harvesting rate) of the RFID device 225 from the one or more of RF sources (e.g., the wireless device 205-a). The control node 210 or the wireless device 205-a may indicate the RF resources, the CSI-RS resources, or both to other devices, such as the RF readers if they are different from RF source, or any devices that may estimate a channel between themselves and one or more RF sources (e.g., the control node 210 or the wireless device 205-a), where an RF source may be a base station.

In some examples, the RFID device 225 may refrain from performing backscattering operations during the CSI-RS resources, and may perform the backscattering operations for SRS transmissions, data retrieved from the RFID device 225, or both. The RF source (e.g., the wireless device 205-a) may send a CSI-RS, and the RFID device 225 may use the CSI-RS or one or more other devices (e.g., the wireless device 205-b) to estimate their own channels to the RF source, where the RF source may be a base station, another UE, an IAB, or any other wireless device. Thus, the CSI-RS may be broadcast, groupcast, or unicast reference signals. Because the RF readers, or other devices, estimate their own CSI through the same CSI-RS resources, the network (e.g., base station, network entity, or network unit, even if the network is not the RF source or one of the RF sources) and/or the RF source may indicate, or communicate, the one or more CSI-RS configurations to those devices (e.g., the RF reader or other devices). The devices may estimate their channels (e.g., from the network or RF source to those UEs or devices). Thus, the devices may listen to signals sent to the RFID device 225 (e.g., without backscattering by the RFID device 225 for CSI-RS).

In some examples, the one or more wireless devices 205, the RFID device 225, or both may use one or more SRS resources to estimate a channel between the RFID device 225 and a reader device (e.g., a UE and/or the wireless device 205-b) or an overall channel between an RF source (e.g., the wireless device 205-a) and an RF reader (e.g., the wireless device 205-b), where an SRS is a backscattered reference signal by the RFID device 225. This SRS may be used to estimate the RFID device 225 to the reader UE, or device (e.g., the wireless device 205-b), if the RFID device 225 normalizes, equalizes, or otherwise removes the channel impact between an RF source to the RFID device 225, based on the RFID device 225 capability (e.g., a reported capability to the network). In some examples, the RFID device 225 may use estimate a normalization, equalization factor, and/or coefficient (e.g., based on previous communication or previous CSI-RS signal). In some other examples, the RFID device 225 may receive a command and/or query from one or more RF sources in accordance with x*b* h1*w, where w is the continuous wave (e.g., the waveform transmission 235) from an RF source, x is an SRS signal (e.g., when there is one SRS port), h1 is the channel coefficient between an RF source and the RFID device 225 (e.g., when there is a single antenna port or antenna at both the RF source and the RFID device 225), and b is the coefficient for reflection of a backscattered signal. For example, the RFID device 225 may perform a backscattering operation using b to backscatter the waveform transmission 235 towards an RF reader (e.g., the wireless device 205-b).

In some cases, the RFID device 225 may have a capability to divide over h1, such ability may include a capability for the RFID device 225 to boost and/or add power to the signal to perform such division operation. That is, for the RFID device 225 to normalize or equalize a signal, the RFID device 225 may add and/or boost power to the incident signal at the RFID device 225, where the power may come from at least one of an RF source signal, an energy storage unit, other energy harvesting techniques (solar, laser, thermal, etc.) or RF energy sources, which may include RF from other networks or technologies (e.g., Bluetooth or Wi-Fi or others) used by the RFID device 225. The RF reader may receive (h2*x*b*h1*w)+additive noise, where h2 is the channel coefficient between the RFID device 225 and the RF reader (e.g., a UE or other device). Thus, if

$$b = \frac{1}{h 1} ,$$

and ignoring noise, the received signal may be h2*x*w. Since the RF reader knows w and x, the RF reader may also determine h2. In some other cases, the one or more wireless devices 205, the RFID device 225, or both may estimate an end-to-end channel, where the RFID device 225 is not normalizing or removing the channel between the RF source to the RFID device 225.

In some cases, the RFID device 225 may receive a report about a channel between the RFID device 225 and the RF reader and may normalize or remove the channel impact between the RFID device 225 and the RF reader, such that the network or RF source may estimate the channel between RF source and the RFID device 225. The network or RF source estimating a link channel or end-to-end may be based on a Layer 1 (L1), Layer 2 (L2), or Layer 3 (L3) indication to the RFID device 225 through commands and/or queries. Since the RF readers or other devices estimate their own CSI through the same SRS resources, the network may indicate the SRS configuration to the RF readers.

In some examples, other RF readers, RF sources, or both knowing the SRS configuration of the RFID device 225 may help in determining RF sources and RF readers for communication with the RFID device 225, or a plurality of the RFID devices, through channel estimation done by reflection and/or backscatter from the RFID device 225 for the RF source signal. DO may be an RF source device that may sound the channel to the RFID device 225 for a first duration or may perform sounding and/or may send data at a later time. So, DO may send a continuous RF waveform transmission including data, a reference signal, or a random or deterministic signal carried on single tone or multi-tone or OFDM-based waveform. The RFID device 225 may backscatter the signal. Then, other devices, such as D1, D2, D3, and/or D4, which may be potential RF readers or RF sources at a future time, may estimate their channel coefficients to the RFID device 225 or the channel from the RF source to the RFID device 225 to one of the devices (e.g., D1, D2, D3, and/or D4). In some examples, the RF reader or RF source or joint RF source and RF reader (or a set of RF sources or RF readers) may be selected based on such measurements of channels, power, or charging at RFID device 225 based on CSI reports or measured CSI metric from one or more RFID devices to the RF source and/or reader devices.

In some examples, instead of sending the continuous RF waveform transmission as a single tone or multi-tone without a specific purpose, an RF source may send a reference signal (e.g., a CSI-RS, an SRS, or both) or data. The RFID device 225 may add a backscattering sequence for the SRS, such that other devices (e.g., UEs) may estimate their own channel (e.g., if the continuous RF waveform transmission is a reference signal) or to receive data. The other devices may receive an indication of a configuration for the continuous RF waveform transmission and the type of the reference signal configuration (e.g., the SRS configuration, CSI-RS configuration). The devices may receive the configurations from the RF source (e.g., the wireless device 205-b may receive an indication from the wireless device 205-a via the communication link 220), the network, a network entity, assigned node by the network, or any other device.

Additionally, or alternatively, the network or the RF source may send an SRS and the RFID device 225 may backscatter the SRS with a sequence (e.g., a common sequence or a sequence dedicated for the RFID device 225). In some cases, the RFID device 225 may generate the sequence or the wireless device 205-a may signal the sequence to the RFID device 225 based on the capability response 275. The RFID device 225 may normalize or equalize any of the channels. If the RFID device 225 has the ability to generate signals (e.g., the RFID device 225 has the ability to generate a signal or waveform) based on a class of the RFID device 225 or a capability, the RFID device 225 may obtain the power or energy partially from the RF source or a storage unit, such as charged by a RF from the RF source, a RF from the network, a RF from another network, another technology (Wi-Fi, Bluetooth, etc.), other energy harvesting technology (solar, thermal, vibration, laser, etc.), or any combination thereof. The RFID device 225 may generate the SRS using the sequence, such as a sequence from the RF source or the network if the RFID device 225 does not generate the sequence. In this case, the channel between the RF source and the RFID device 225 may not impact the received signal by one or more RF readers. In summary, the RFID device 225 may generate the SRS sequence (e.g., if the RFID device 225 is capable) or the SRS sequence may be signaled by the network, an RF source, or both (e.g., as part of the SRS configuration in the reference signal trigger message 255). The RFID device 225 may generate a waveform just like a semi-active or active device (e.g., the RFID device 225 may have active RF components and RF hardware, and/or software to generate a waveform). The power to the RFID device 225 may partially come from an RF source or other power sources.

In some cases, the RF source may collect CSI reports from the RFID device 225 and other devices, one dedicated unit, or a base station. The other devices, dedicated unit, or the base station may determine one or more RF sources and readers for the RFID device 225 based on the collected information. The links and/or interfaces used to collect the CSI may be new links/interfaces, network to UE (e.g., Uu), sidelink, Bluetooth, Wi-Fi, or any other links that the UEs may use.

In some examples, a capability of the RFID device 225 to generate the sequences (e.g., CSI-RS sequence, SRS sequence, or both) or the RFID device 225 receiving the sequences from the network may change over time, such as based on a power profile, an energy profile, or both at the RFID device 225. The power profile, the energy profile, or both may include a charging rate from one or more of energy harvesting technologies, a charging rate profile (e.g., current charging rate and a charging rate predicted over one or more of time durations), a discharging rate (e.g., power consumption), a discharging rate profile (e.g., a current discharging rate and a discharging rate predicted over one or more of time durations), energy state, energy state profile (e.g., how much energy is in an energy storage unit or an energy level), or any combination thereof.

FIG. 3 illustrates an example of a resource diagram 300 that supports reference signal design for passive wireless devices in accordance with one or more aspects of the present disclosure. In some examples, resource diagram 300 may implement, or be implemented by, aspects of the wireless communications system 100 and the wireless communications system 200. For example, the resource diagram 300 may be implemented by a wireless communications system with one or more wireless devices and one or more RFID devices as described with reference to FIGS. 1 and 2. A wireless device, such as a UE or a network entity, may use a continuous waveform transmission 305 to send one or more parameters for an RFID device to use to perform a CSI report, send SRSs, or both.

In some examples, an RFID device may perform one or more CSI-RS measurements and reporting as well as one or more SRS transmissions while a wireless device (e.g., an RF source) is transmitting a continuous waveform transmission 305. In some examples, the continuous waveform transmission 305 may span one or more time units, which may be referred to as communication slots 310. The communication slots 310 may be dedicated for uplink transmissions from a wireless device (e.g., a UE) to a network entity, for downlink transmissions to the wireless device from the network entity or may be flexible including both uplink and downlink transmissions. In some examples, the communications to the RFID device 315 and the communications from the RFID device 320 may be uplink or downlink. For example, if the communications to the RFID device 315 are from a network entity (e.g., the wireless device sending the continuous waveform transmission 305 is a network entity), and the communications from the RFID device 320 are to a UE, then the communications are downlink. Similarly, if the communications to the RFID device 315 are from a UE (e.g., the wireless device sending the continuous waveform transmission 305 is a UE), and the communications from the RFID device 320 are to a network entity, then the communications are uplink. In some examples, both the communication to the RFID device 315 and the communications from the RFID device 320 may be to a single wireless device, which may be uplink or downlink. That is, a UE or a network entity may transmit communications to the RFID device 315 during downlink or uplink slots.

In some cases, a wireless device may send a capability enquiry 325 to the RFID device during the continuous waveform transmission 305. The capability enquiry 325 may request the RFID device to send one or more capabilities related to performing a CSI report, SRS transmissions, or both. The RFID device may respond with a capability response 330 by modulating the continuous waveform transmission 305 (e.g., according to an ASK modulation scheme). The wireless device may select one or more parameters to include in a trigger message 335 to the RFID device, such as based on the information in the capability response 330. The trigger message 335 may trigger a reference signal measurement at the RFID device during the reference signal measurement duration 340, which may span a portion of a communication slot 310 or one or more communication slots 310. Once the RFID device performs the reference signal measurements, such as measurements of one or more CSI-RSs (e.g., an RSRP, RSRQ, or any additional reference signal measurements), the RFID device may prepare and send a reference signal message 345. The reference signal message 345 may include a CSI report, one or more backscattered SRSs, or both.

In some examples, the wireless device may send a query 350 to the RFID device based on the reference signal message 345. The query may trigger one or more transmissions from the RFID device, to the RFID device, or both, such as data or control information transmissions.

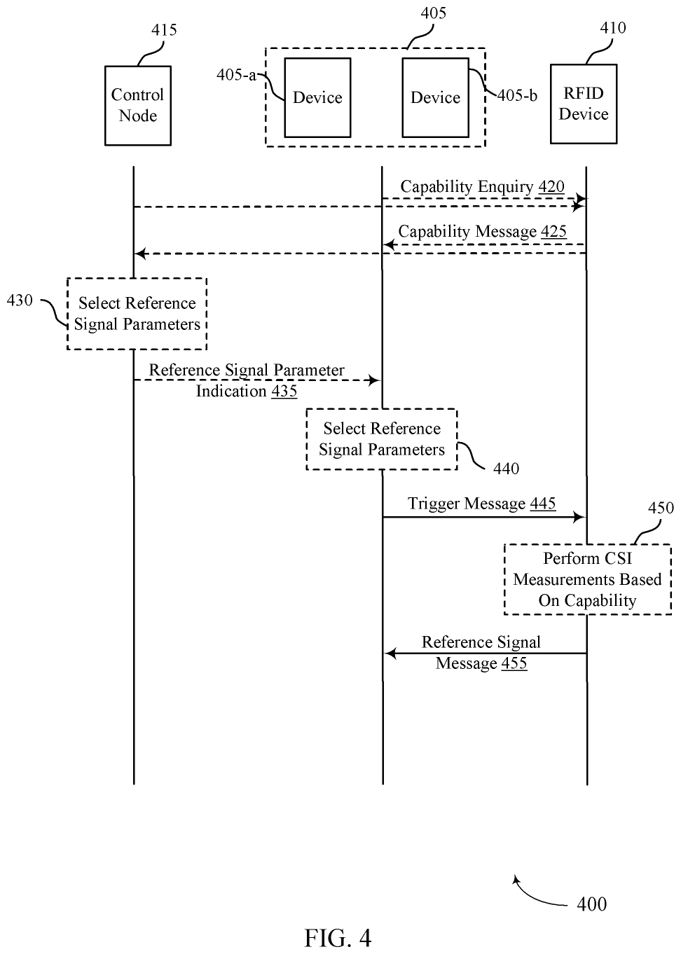

FIG. 4 illustrates an example of a process flow 400 that supports reference signal design for passive wireless devices in accordance with one or more aspects of the present disclosure. In some examples, the process flow 400 may implement aspects of the wireless communications system 100, the wireless communications system 200, and the resource diagram 300. The process flow 400 may illustrate an example of one or more wireless devices, such as a wireless device 405-a and a wireless device 405-b, selecting and sending parameters for a CSI report and/or SRS transmission from an RFID device 410. The wireless device 405-a and the wireless device 405-b may be examples of a UE 115, network entity 105, network node, network unit, IAB relay, relay, RAN node, or any other active wireless device, such as those described with reference to FIGS. 1 and 2. Similarly, a control node 415 may be an example of a network entity 105, a network node, a base station, or any other controlling wireless device, such as those described with reference to FIGS. 1 and 2. Alternative examples of the following may be implemented, where some processes are performed in a different order than described or are not performed. In some cases, processes may include additional features not mentioned below, or further processes may be added.

In some examples, one or more wireless devices (e.g., the control node 415, one or more wireless devices 405 including the wireless device 405-a, the wireless device 405-b, or both) may communicate with an RFID device 410 in a wireless communications system, such as an IoT system, a UHF RFID system, or any other communications system. The RFID device 410 may be an example of a reduced capability device without a power source, battery, or both that may use power from electromagnetic signals (e.g., a waveform transmission) to activate. The waveform transmission may be a continuous wave transmission, a modulated wave transmission, or any other type of signaling. The RFID device 410 may have RFID tag circuitry with a capacitor (e.g., supercapacitor) and a reference signal processing unit. Once the capacitor discharges below a threshold level, the RFID device 410 may deactivate. In some examples, the one or more wireless devices 205 may send a continuous wave, or any other type of waveform, to activate the RFID device 410.

At 420, the RFID device 410 may receive a capability enquiry message. For example, the RFID device 410 may receive the capability enquiry message from the one or more wireless devices 405 (e.g., the wireless device 405-a, the wireless device 405-b, or both), the control node 415, or both via a continuous RF waveform, which may be referred to as a continuous wave transmission or a waveform transmission.

At 425, the RFID device 410 may send a capability message to the one or more wireless devices 405 (e.g., the wireless device 405-a, the wireless device 405-b, or both), the control node 415, or both via the continuous RF waveform, such as in a portion of a modulated continues RF waveform. The capability message may indicate the capability of the RFID device 410 to perform one or more operations related to reference signals (e.g., a CSI report, an SRS transmission, or both). In some cases, the RFID device 410 may transmit the capability message based on receiving the capability enquiry at 420. In some other cases, the RFID device 410 may transmit the capability message after initial communication establishment, where the enquiry is implied by the communication establishment (e.g., not a direct message).

In some examples, the capability may be based on a device class for the RFID device 410, which may depend on reference signal configurations, a first storage for the one or more reference signal configurations, one or more message configurations, a second storage for the one or more message configurations, an SRS, a port sounding capability, or any combination thereof. The one or more message configurations may indicate a reference signal sequence, a resource allocation for a reference signal, requested content for a message, a charging rate, an input power level, a power measurement (e.g., RSRP), a pathloss measurement, a signal quality measurement (e.g., RSRQ), an SRS trigger, an SRS sequence, a timing parameter, or any combination thereof.

In some cases, at 430, the control node 415 may select reference signal parameters for the RFID device 410 to use for one or more reference signal related messages, such as a CSI report or SRS transmission. The selection may be in accordance with the capability message from the RFID device 410.

At 435, the control node 415 may send the reference signal parameters to the one or more wireless devices 405 in an indication for them to send to the RFID device 410, or may send the reference signal parameters directly to the RFID device in an indication. The control node 415 may include the indication of the parameters in control signaling, such as RRC signaling, a downlink control information (DCI) message, a broadcast message, a medium access control-control element (MAC-CE), or any other type of control signaling.

In some examples, at 440, the one or more wireless devices 405 may select the reference signal parameters for the RFID device 410 to use for one or more reference signal related messages, such as a CSI report or SRS transmission. The one or more wireless devices may select the reference signal parameters based on the message from the control node 415, or independent of the control node 415. For example, if the wireless device 405-a and the wireless device 405-b are both UEs, the wireless devices 405 may select the reference signal parameters based on the indication from the control node 415. In some other examples, if one of the wireless device 405-a or the wireless device 405-b is a network entity, the network entity may select the reference signal parameters.

At 445, the RFID device 410 may receive a trigger message from the one or more wireless devices 405 via a continuous RF waveform that activates the RFID device 410. The trigger message may indicate one or more parameters for a reference signal transmission or measurement operation, where the reference signal is transmitted or received at (e.g., associated with) the one or more wireless devices 405 and the RFID device 410.

In some cases, the trigger message may include a scrambling sequence dedicated for the RFID device 410, dedicated for the reference signal, or both. The one or more parameters may indicate orthogonal resources in a time or frequency domain based on a port sounding capability of the RFID device 410. Additionally, or alternatively, the one or more parameters may indicate one or more antenna ports to be used for data communication at the RFID device 410. In some cases, the one or more parameters may be based on a memory capability of the RFID device 410 for a current communication period, a previous communication period, or both (e.g., stored or loaded values of the parameters that the RFID device 410 may access).

At 450, the RFID device 410 may perform one or more operations in response to the trigger message. The one or more operations may be in accordance with the capability of the RFID device 410 and the one or more parameters.

In some cases, the operations may include measuring CSI for one or more CSI-RSs, performing a port sounding procedure for an SRS based on a quantity of antennas at the RFID device 410 (e.g., where the one or more parameters indicate an order or a rank for the port sounding procedure), or both.

At 455, the RFID device 410 may modulate the continuous RF waveform (e.g., using ASK modulation) based on the reference signal. That is, the RFID device 410 may send a message via a portion of the modulated continuous RF waveform, the message indicating a CSI report, an SRS transmission, or both based on the capability of the RFID device 410.

In some cases, the message may include the CSI report, which may indicate the CSI. Additionally, or alternatively, the message may include an SRS in accordance with the one or more parameters. For example, the RFID device 410 may send an SRS via the continuous RF waveform during an uplink slot, a downlink slot, or both. Similarly, the RFID device 410 may send a CSI report via the continuous RF waveform during the uplink slot, the downlink slot, or both.

In some examples, the RFID device 410 may send an indication of at least one of a capacitor size, the device class of the RFID device 410, a power splitting circuit, a power splitting factor, a condition for performing power splitting, an energy capacity time, and a communication or backscattering time via the portion of the modulated continuous RF waveform. Additionally, or alternatively, the RFID device 410 may send an additional report message indicating an input power level via the portion of the modulated continuous RF waveform.

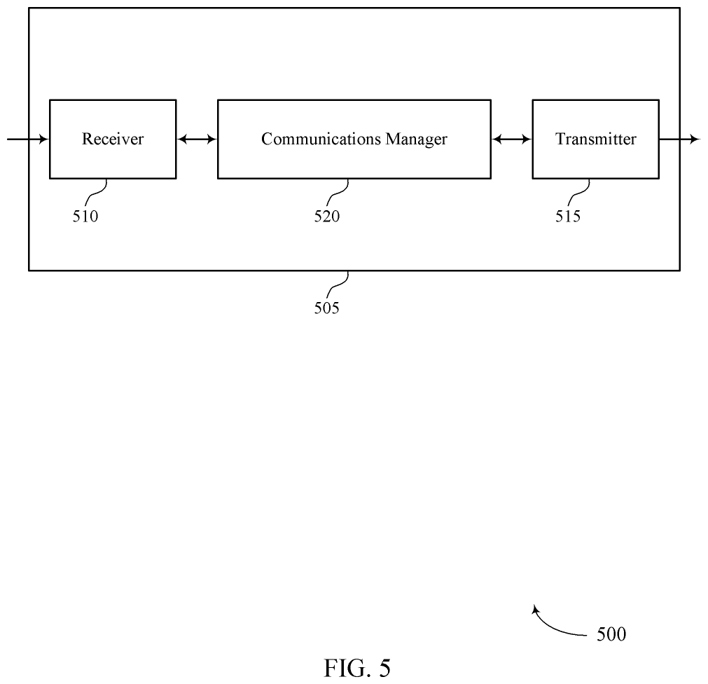

FIG. 5 shows a block diagram 500 of a device 505 that supports reference signal design for passive wireless devices in accordance with one or more aspects of the present disclosure. The device 505 may be an example of aspects of a wireless device as described herein. The device 505 may include a receiver 510, a transmitter 515, and a communications manager 520. The device 505 may also include a processor. Each of these components may be in communication with one another (e.g., via one or more buses).

The receiver 510 may provide a means for receiving information such as packets, user data, control information, or any combination thereof associated with various information channels (e.g., control channels, data channels, information channels related to reference signal design for passive wireless devices). Information may be passed on to other components of the device 505. The receiver 510 may utilize a single antenna or a set of multiple antennas.

The transmitter 515 may provide a means for transmitting signals generated by other components of the device 505. For example, the transmitter 515 may transmit information such as packets, user data, control information, or any combination thereof associated with various information channels (e.g., control channels, data channels, information channels related to reference signal design for passive wireless devices). In some examples, the transmitter 515 may be co-located with a receiver 510 in a transceiver module. The transmitter 515 may utilize a single antenna or a set of multiple antennas.

The communications manager 520, the receiver 510, the transmitter 515, or various combinations thereof or various components thereof may be examples of means for performing various aspects of reference signal design for passive wireless devices as described herein. For example, the communications manager 520, the receiver 510, the transmitter 515, or various combinations or components thereof may support a method for performing one or more of the functions described herein.

In some examples, the communications manager 520, the receiver 510, the transmitter 515, or various combinations or components thereof may be implemented in hardware (e.g., in communications management circuitry). The hardware may include a processor, a digital signaling processor (DSP), a central processing unit (CPU), a graphics processing unit (GPU), an application-specific integrated circuit (ASIC), an field-programmable gate array (FPGA) or other programmable logic device, a microcontroller, discrete gate or transistor logic, discrete hardware components, or any combination thereof configured as or otherwise supporting a means for performing the functions described in the present disclosure. In some examples, a processor and memory coupled with the processor may be configured to perform one or more of the functions described herein (e.g., by executing, by the processor, instructions stored in the memory).

Additionally, or alternatively, in some examples, the communications manager 520, the receiver 510, the transmitter 515, or various combinations or components thereof may be implemented in code (e.g., as communications management software) executed by a processor. Software shall be construed broadly to mean instructions, instruction sets, code, code segments, program code, programs, subprograms, software modules, applications, software applications, software packages, routines, subroutines, objects, executables, threads of execution, procedures, or functions, whether referred to as software, firmware, middleware, microcode, hardware description language, or otherwise. If implemented in code executed by a processor, the functions of the communications manager 520, the receiver 510, the transmitter 515, or various combinations or components thereof may be performed by a general-purpose processor, a DSP, a CPU, an ASIC, an FPGA, a microcontroller, or any combination of these or other programmable logic devices (e.g., configured as or otherwise supporting a means for performing the functions described in the present disclosure).

In some examples, the communications manager 520 may be configured to perform various operations (e.g., receiving, obtaining, monitoring, outputting, transmitting) using or otherwise in cooperation with the receiver 510, the transmitter 515, or both. For example, the communications manager 520 may receive information from the receiver 510, send information to the transmitter 515, or be integrated in combination with the receiver 510, the transmitter 515, or both to obtain information, output information, or perform various other operations as described herein.

The communications manager 520 may support wireless communication at a first wireless device in accordance with examples as disclosed herein. For example, the communications manager 520 may be configured as or otherwise support a means for receiving, via a continuous RF waveform that activates the first wireless device, a trigger message from a second wireless device, the trigger message indicating one or more parameters associated with a reference signal associated with the first wireless device and the second wireless device. The communications manager 520 may be configured as or otherwise support a means for modulating the continuous RF waveform based on the reference signal. The communications manager 520 may be configured as or otherwise support a means for sending, via a portion of the modulated continuous RF waveform, a message associated with the reference signal based on the one or more parameters and a capability of the first wireless device.

Additionally, or alternatively, the communications manager 520 may support wireless communication at a first wireless device in accordance with examples as disclosed herein. For example, the communications manager 520 may be configured as or otherwise support a means for transmitting, via a continuous RF waveform that activates a second wireless device, a trigger message to the second wireless device, the trigger message indicating one or more parameters associated with a reference signal associated with the first wireless device and the second wireless device. The communications manager 520 may be configured as or otherwise support a means for receiving, via a modulated portion of the continuous RF waveform, a message associated with the reference signal based on the one or more parameters and a capability of the second wireless device.

By including or configuring the communications manager 520 in accordance with examples as described herein, the device 505 (e.g., a processor controlling or otherwise coupled with the receiver 510, the transmitter 515, the communications manager 520, or a combination thereof) may support techniques for one or more wireless devices selecting and sending parameters for a CSI report and/or SRS transmission from an RFID device via a continuous RF wave transmission, which may provide for reduced processing, reduced power consumption, more efficient utilization of communication resources, among other advantages.

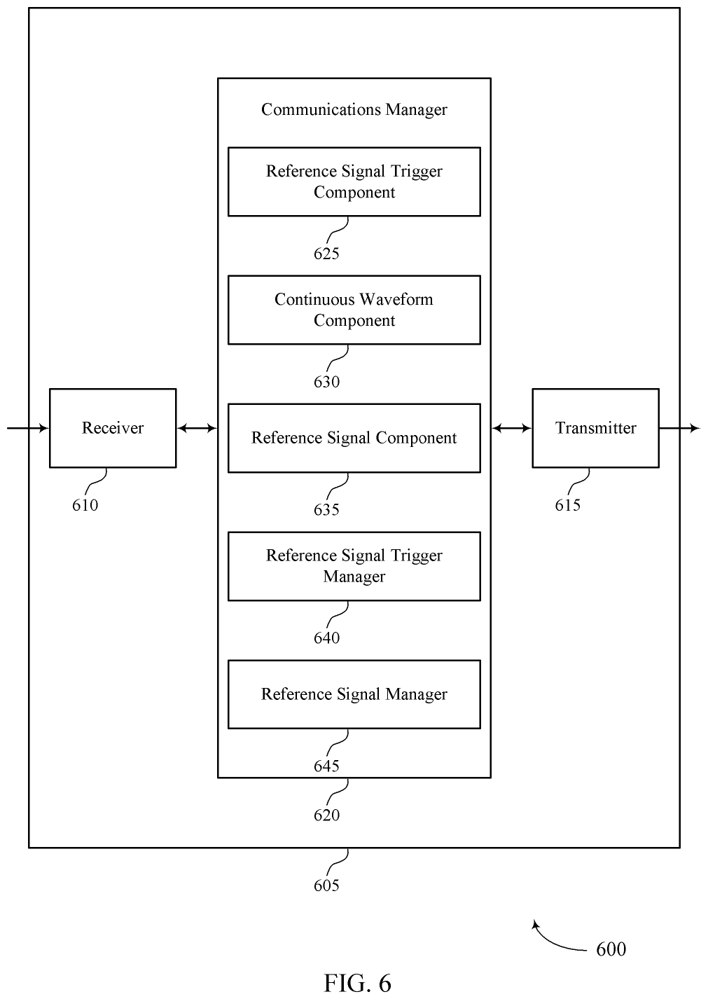

FIG. 6 shows a block diagram 600 of a device 605 that supports reference signal design for passive wireless devices in accordance with one or more aspects of the present disclosure. The device 605 may be an example of aspects of a device 505 or a wireless device (e.g., a UE 115 or a network entity 105) as described herein. The device 605 may include a receiver 610, a transmitter 615, and a communications manager 620. The device 605 may also include a processor. Each of these components may be in communication with one another (e.g., via one or more buses).

The receiver 610 may provide a means for receiving information such as packets, user data, control information, or any combination thereof associated with various information channels (e.g., control channels, data channels, information channels related to reference signal design for passive wireless devices). Information may be passed on to other components of the device 605. The receiver 610 may utilize a single antenna or a set of multiple antennas.

The transmitter 615 may provide a means for transmitting signals generated by other components of the device 605. For example, the transmitter 615 may transmit information such as packets, user data, control information, or any combination thereof associated with various information channels (e.g., control channels, data channels, information channels related to reference signal design for passive wireless devices). In some examples, the transmitter 615 may be co-located with a receiver 610 in a transceiver module. The transmitter 615 may utilize a single antenna or a set of multiple antennas.

The device 605, or various components thereof, may be an example of means for performing various aspects of reference signal design for passive wireless devices as described herein. For example, the communications manager 620 may include a reference signal trigger component 625, a continuous waveform component 630, a reference signal component 635, a reference signal trigger manager 640, a reference signal manager 645, or any combination thereof. The communications manager 620 may be an example of aspects of a communications manager 520 as described herein. In some examples, the communications manager 620, or various components thereof, may be configured to perform various operations (e.g., receiving, obtaining, monitoring, outputting, transmitting) using or otherwise in cooperation with the receiver 610, the transmitter 615, or both. For example, the communications manager 620 may receive information from the receiver 610, send information to the transmitter 615, or be integrated in combination with the receiver 610, the transmitter 615, or both to obtain information, output information, or perform various other operations as described herein.

The communications manager 620 may support wireless communication at a first wireless device in accordance with examples as disclosed herein. The reference signal trigger component 625 may be configured as or otherwise support a means for receiving, via a continuous RF waveform that activates the first wireless device, a trigger message from a second wireless device, the trigger message indicating one or more parameters associated with a reference signal associated with the first wireless device and the second wireless device. The continuous waveform component 630 may be configured as or otherwise support a means for modulating the continuous RF waveform based on the reference signal. The reference signal component 635 may be configured as or otherwise support a means for sending, via a portion of the modulated continuous RF waveform, a message associated with the reference signal based on the one or more parameters and a capability of the first wireless device.

Additionally, or alternatively, the communications manager 620 may support wireless communication at a first wireless device in accordance with examples as disclosed herein. The reference signal trigger manager 640 may be configured as or otherwise support a means for transmitting, via a continuous RF waveform that activates a second wireless device, a trigger message to the second wireless device, the trigger message indicating one or more parameters associated with a reference signal associated with the first wireless device and the second wireless device. The reference signal manager 645 may be configured as or otherwise support a means for receiving, via a modulated portion of the continuous RF waveform, a message associated with the reference signal based on the one or more parameters and a capability of the second wireless device.

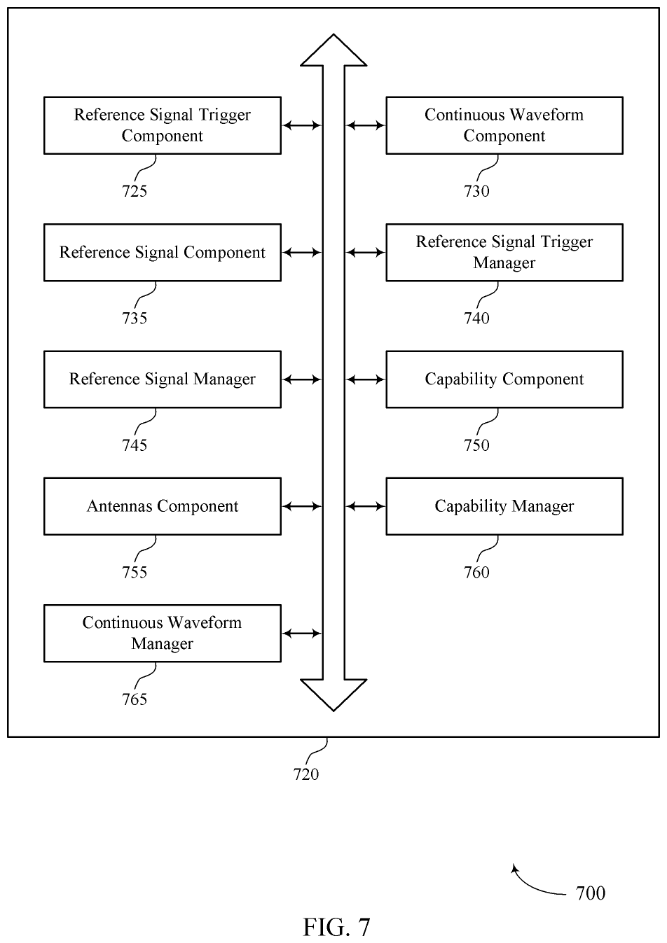

FIG. 7 shows a block diagram 700 of a communications manager 720 that supports reference signal design for passive wireless devices in accordance with one or more aspects of the present disclosure. The communications manager 720 may be an example of aspects of a communications manager 520, a communications manager 620, or both, as described herein. The communications manager 720, or various components thereof, may be an example of means for performing various aspects of reference signal design for passive wireless devices as described herein. For example, the communications manager 720 may include a reference signal trigger component 725, a continuous waveform component 730, a reference signal component 735, a reference signal trigger manager 740, a reference signal manager 745, a capability component 750, an antennas component 755, a capability manager 760, a continuous waveform manager 765, or any combination thereof. Each of these components may communicate, directly or indirectly, with one another (e.g., via one or more buses).

The communications manager 720 may support wireless communication at a first wireless device in accordance with examples as disclosed herein. The reference signal trigger component 725 may be configured as or otherwise support a means for receiving, via a continuous RF waveform that activates the first wireless device, a trigger message from a second wireless device, the trigger message indicating one or more parameters associated with a reference signal associated with the first wireless device and the second wireless device. The continuous waveform component 730 may be configured as or otherwise support a means for modulating the continuous RF waveform based on the reference signal. The reference signal component 735 may be configured as or otherwise support a means for sending, via a portion of the modulated continuous RF waveform, a message associated with the reference signal based on the one or more parameters and a capability of the first wireless device.

In some examples, the reference signal component 735 may be configured as or otherwise support a means for performing, in response to the trigger message, one or more operations based on the capability of the first wireless device and the one or more parameters.

In some examples, performing the one or more operations includes measuring CSI associated with the reference signal. In some examples, sending the message includes sending a CSI report including the CSI.

In some examples, to support sending the message, the reference signal component 735 may be configured as or otherwise support a means for sending an SRS via the portion of the modulated continuous RF waveform based on the one or more parameters.

In some examples, the capability component 750 may be configured as or otherwise support a means for receiving, via the continuous RF waveform, a capability enquiry message. In some examples, the capability component 750 may be configured as or otherwise support a means for sending, via the continuous RF waveform, a capability message indicating the capability of the first wireless device based on receiving the capability enquiry message.

In some examples, to support receiving the trigger message, the reference signal trigger component 725 may be configured as or otherwise support a means for receiving the trigger message including a scrambling sequence dedicated for the first wireless device, dedicated for the reference signal, or both.

In some examples, to support sending the message, the reference signal component 735 may be configured as or otherwise support a means for sending an SRS via the continuous RF waveform during an uplink slot, a downlink slot, or both.

In some examples, to support sending the message, the reference signal component 735 may be configured as or otherwise support a means for sending a CSI report via the continuous RF waveform during the uplink slot, the downlink slot, or both.

In some examples, the antennas component 755 may be configured as or otherwise support a means for performing a port sounding procedure associated with the reference signal based on a quantity of antennas at the first wireless device.

In some examples, the one or more parameters indicate an order or a rank for the port sounding procedure.

In some examples, the capability of the first wireless device is based at least on a device class associated with one or more reference signal configurations, a first storage for the one or more reference signal configurations, one or more message configurations, a second storage for the one or more message configurations, an SRS, a port sounding capability, or any combination thereof.

In some examples, the one or more message configurations indicates a reference signal sequence, a resource allocation associated with the reference signal, requested content for the message, a charging rate, an input power level, a power measurement, a pathloss measurement, a signal quality measurement, an SRS trigger, an SRS sequence, a timing parameter, or any combination thereof.

In some examples, to support sending the message, the continuous waveform component 730 may be configured as or otherwise support a means for sending, via the portion of the modulated continuous RF waveform, an indication of at least one of a capacitor size, the device class, a power splitting circuit, a power splitting factor, a condition for performing power splitting, an energy capacity time, and a communication or backscattering time.

In some examples, the one or more parameters indicate orthogonal resources in a time or frequency domain based on the port sounding capability.

In some examples, the one or more parameters indicate one or more antenna ports associated with data communication at the first wireless device.

In some examples, the continuous waveform component 730 may be configured as or otherwise support a means for sending, via the portion of the modulated continuous RF waveform, an additional report message indicating an input power level.

In some examples, the one or more parameters associated with the reference signal is based on a memory capability of the first wireless device.

In some examples, a memory of the first wireless device is associated with the capability of the first wireless device in a current communication period, a previous communication period, or both.

Additionally, or alternatively, the communications manager 720 may support wireless communication at a first wireless device in accordance with examples as disclosed herein. The reference signal trigger manager 740 may be configured as or otherwise support a means for transmitting, via a continuous RF waveform that activates a second wireless device, a trigger message to the second wireless device, the trigger message indicating one or more parameters associated with a reference signal associated with the first wireless device and the second wireless device. The reference signal manager 745 may be configured as or otherwise support a means for receiving, via a modulated portion of the continuous RF waveform, a message associated with the reference signal based on the one or more parameters and a capability of the second wireless device.

In some examples, to support receiving the message, the reference signal manager 745 may be configured as or otherwise support a means for receiving a CSI report including CSI.

In some examples, to support receiving the message, the reference signal manager 745 may be configured as or otherwise support a means for receiving an SRS via the modulated portion of the continuous RF waveform based on the one or more parameters.

In some examples, the capability manager 760 may be configured as or otherwise support a means for transmitting, via the continuous RF waveform, a capability enquiry message. In some examples, the capability manager 760 may be configured as or otherwise support a means for receiving, via the continuous RF waveform, a capability message indicating the capability of the second wireless device based on receiving the capability enquiry message.

In some examples, to support transmitting the trigger message, the reference signal trigger manager 740 may be configured as or otherwise support a means for transmitting the trigger message including a scrambling sequence dedicated for the second wireless device, dedicated for the reference signal, or both.

In some examples, to support receiving the message, the reference signal manager 745 may be configured as or otherwise support a means for receiving an SRS via the continuous RF waveform during an uplink slot, a downlink slot, or both.

In some examples, to support receiving the message, the reference signal manager 745 may be configured as or otherwise support a means for receiving a CSI report via the continuous RF waveform during the uplink slot, the downlink slot, or both.

In some examples, the one or more parameters indicate an order or a rank for a port sounding procedure at the second wireless device.

In some examples, the capability of the second wireless device is based at least on a device class associated with one or more reference signal configurations, a first storage for the one or more reference signal configurations, one or more message configurations, a second storage for the one or more message configurations, an SRS, a port sounding capability, or any combination thereof.

In some examples, the one or more message configurations indicates a reference signal sequence, a resource allocation associated with the reference signal, requested content for the message, a charging rate, an input power level, a power measurement, a pathloss measurement, a signal quality measurement, an SRS trigger, an SRS sequence, a timing parameter, or any combination thereof.

In some examples, to support sending the message, the continuous waveform manager 765 may be configured as or otherwise support a means for receiving, via the modulated portion of the continuous RF waveform, an indication of at least one of a capacitor size, the device class, a power splitting circuit, a power splitting factor, a condition for performing power splitting, an energy capacity time, and a communication or backscattering time.

In some examples, the one or more parameters indicate orthogonal resources in a time or frequency domain based on the port sounding capability.

In some examples, the one or more parameters indicate one or more antenna ports associated with data communication at the second wireless device.

In some examples, the continuous waveform manager 765 may be configured as or otherwise support a means for receiving, via the modulated portion of the continuous RF waveform, an additional report message indicating an input power level.

In some examples, the one or more parameters associated with the reference signal is based on a memory capability of the second wireless device.

In some examples, a memory of the second wireless device is associated with the capability of the second wireless device in a current communication period, a previous communication period, or both.

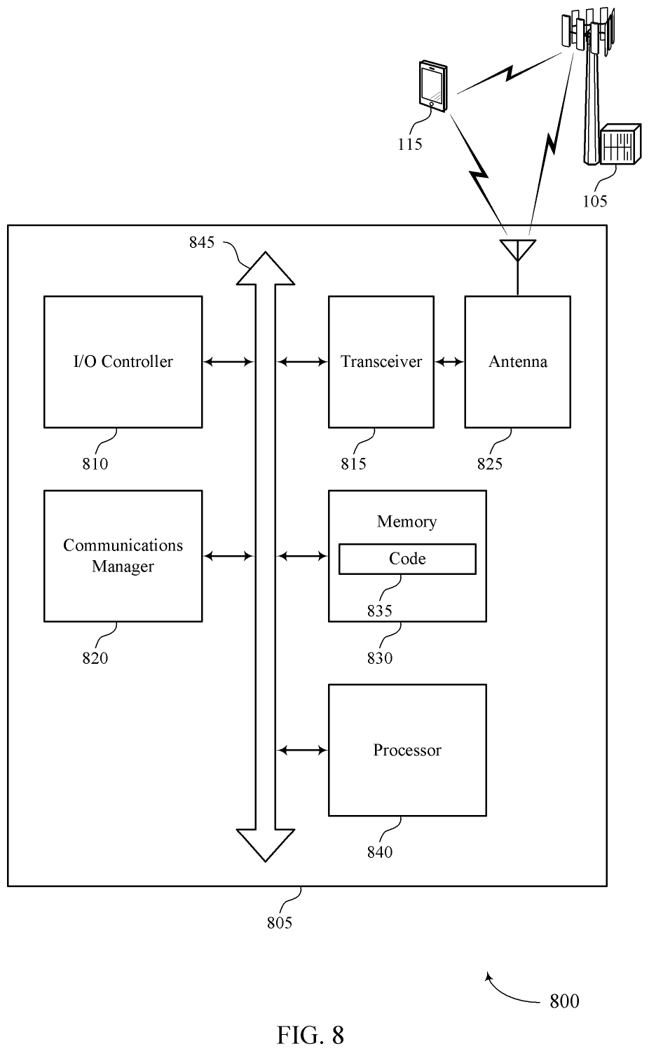

FIG. 8 shows a diagram of a system 800 including a device 805 that supports reference signal design for passive wireless devices in accordance with one or more aspects of the present disclosure. The device 805 may be an example of or include the components of a device 505, a device 605, or a wireless device as described herein. The device 805 may include components for bi-directional voice and data communications including components for transmitting and receiving communications, such as a communications manager 820, an I/O controller 810, a transceiver 815, an antenna 825, a memory 830, code 835, and a processor 840. These components may be in electronic communication or otherwise coupled (e.g., operatively, communicatively, functionally, electronically, electrically) via one or more buses (e.g., a bus 845).

The I/O controller 810 may manage input and output signals for the device 805. The I/O controller 810 may also manage peripherals not integrated into the device 805. In some cases, the I/O controller 810 may represent a physical connection or port to an external peripheral. In some cases, the I/O controller 810 may utilize an operating system such as iOS®, ANDROID®, MS-DOS®, MS-WINDOWS®, OS/2®, UNIX®, LINUX®, or another known operating system. Additionally, or alternatively, the I/O controller 810 may represent or interact with a modem, a keyboard, a mouse, a touchscreen, or a similar device. In some cases, the I/O controller 810 may be implemented as part of a processor, such as the processor 840. In some cases, a user may interact with the device 805 via the I/O controller 810 or via hardware components controlled by the I/O controller 810.

In some cases, the device 805 may include a single antenna 825. However, in some other cases, the device 805 may have more than one antenna 825, which may be capable of concurrently transmitting or receiving multiple wireless transmissions. The transceiver 815 may communicate bi-directionally, via the one or more antennas 825, wired, or wireless links as described herein. For example, the transceiver 815 may represent a wireless transceiver and may communicate bi-directionally with another wireless transceiver. The transceiver 815 may also include a modem to modulate the packets, to provide the modulated packets to one or more antennas 825 for transmission, and to demodulate packets received from the one or more antennas 825. The transceiver 815, or the transceiver 815 and one or more antennas 825, may be an example of a transmitter 515, a transmitter 615, a receiver 510, a receiver 610, or any combination thereof or component thereof, as described herein.

The memory 830 may include RAM and ROM. The memory 830 may store computer-readable, computer-executable code 835 including instructions that, when executed by the processor 840, cause the device 805 to perform various functions described herein. The code 835 may be stored in a non-transitory computer-readable medium such as system memory or another type of memory. In some cases, the code 835 may not be directly executable by the processor 840 but may cause a computer (e.g., when compiled and executed) to perform functions described herein. In some cases, the memory 830 may contain, among other things, a BIOS which may control basic hardware or software operation such as the interaction with peripheral components or devices.

The processor 840 may include an intelligent hardware device (e.g., a general-purpose processor, a DSP, a CPU, a microcontroller, an ASIC, an FPGA, a programmable logic device, a discrete gate or transistor logic component, a discrete hardware component, or any combination thereof). In some cases, the processor 840 may be configured to operate a memory array using a memory controller. In some other cases, a memory controller may be integrated into the processor 840. The processor 840 may be configured to execute computer-readable instructions stored in a memory (e.g., the memory 830) to cause the device 805 to perform various functions (e.g., functions or tasks supporting reference signal design for passive wireless devices). For example, the device 805 or a component of the device 805 may include a processor 840 and memory 830 coupled with or to the processor 840, the processor 840 and memory 830 configured to perform various functions described herein.

The communications manager 820 may support wireless communication at a first wireless device in accordance with examples as disclosed herein. For example, the communications manager 820 may be configured as or otherwise support a means for receiving, via a continuous RF waveform that activates the first wireless device, a trigger message from a second wireless device, the trigger message indicating one or more parameters associated with a reference signal associated with the first wireless device and the second wireless device. The communications manager 820 may be configured as or otherwise support a means for modulating the continuous RF waveform based on the reference signal. The communications manager 820 may be configured as or otherwise support a means for sending, via a portion of the modulated continuous RF waveform, a message associated with the reference signal based on the one or more parameters and a capability of the first wireless device.

Additionally, or alternatively, the communications manager 820 may support wireless communication at a first wireless device in accordance with examples as disclosed herein. For example, the communications manager 820 may be configured as or otherwise support a means for transmitting, via a continuous RF waveform that activates a second wireless device, a trigger message to the second wireless device, the trigger message indicating one or more parameters associated with a reference signal associated with the first wireless device and the second wireless device. The communications manager 820 may be configured as or otherwise support a means for receiving, via a modulated portion of the continuous RF waveform, a message associated with the reference signal based on the one or more parameters and a capability of the second wireless device.

By including or configuring the communications manager 820 in accordance with examples as described herein, the device 805 may support techniques for one or more wireless devices selecting and sending parameters for a CSI report and/or SRS transmission from an RFID device via a continuous RF wave transmission, which may provide for improved communication reliability, reduced latency, improved user experience related to reduced processing, reduced power consumption, more efficient utilization of communication resources, improved coordination between devices, longer battery life, and improved utilization of processing capability, among other advantages.

In some examples, the communications manager 820 may be configured to perform various operations (e.g., receiving, monitoring, transmitting) using or otherwise in cooperation with the transceiver 815, the one or more antennas 825, or any combination thereof. Although the communications manager 820 is illustrated as a separate component, in some examples, one or more functions described with reference to the communications manager 820 may be supported by or performed by the processor 840, the memory 830, the code 835, or any combination thereof. For example, the code 835 may include instructions executable by the processor 840 to cause the device 805 to perform various aspects of reference signal design for passive wireless devices as described herein, or the processor 840 and the memory 830 may be otherwise configured to perform or support such operations.

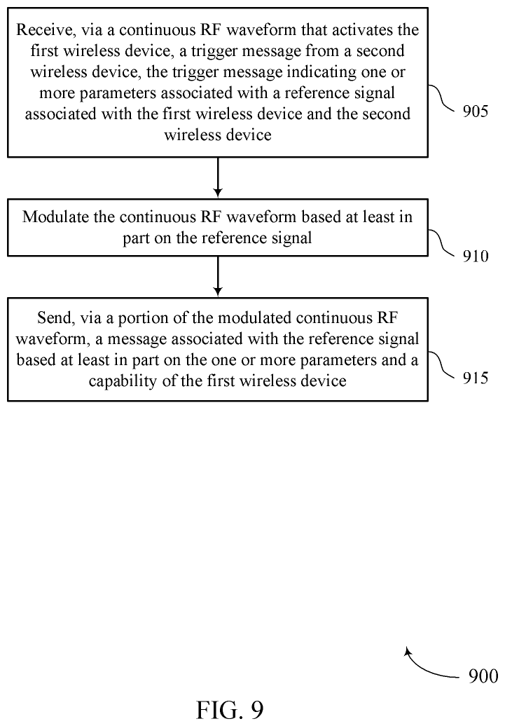

FIG. 9 shows a flowchart illustrating a method 900 that supports reference signal design for passive wireless devices in accordance with one or more aspects of the present disclosure. The operations of the method 900 may be implemented by a wireless device or its components as described herein. For example, the operations of the method 900 may be performed by a wireless device as described with reference to FIGS. 1 through 8. In some examples, a wireless device may execute a set of instructions to control the functional elements of the wireless device to perform the described functions. Additionally, or alternatively, the wireless device may perform aspects of the described functions using special-purpose hardware.

At 905, the method may include receiving, via a continuous RF waveform that activates the first wireless device, a trigger message from a second wireless device, the trigger message indicating one or more parameters associated with a reference signal associated with the first wireless device and the second wireless device. The operations of 905 may be performed in accordance with examples as disclosed herein. In some examples, aspects of the operations of 905 may be performed by a reference signal trigger component 725 as described with reference to FIG. 7.

At 910, the method may include modulating the continuous RF waveform based on the reference signal. The operations of 910 may be performed in accordance with examples as disclosed herein. In some examples, aspects of the operations of 910 may be performed by a continuous waveform component 730 as described with reference to FIG. 7.

At 915, the method may include sending, via a portion of the modulated continuous RF waveform, a message associated with the reference signal based on the one or more parameters and a capability of the first wireless device. The operations of 915 may be performed in accordance with examples as disclosed herein. In some examples, aspects of the operations of 915 may be performed by a reference signal component 735 as described with reference to FIG. 7.

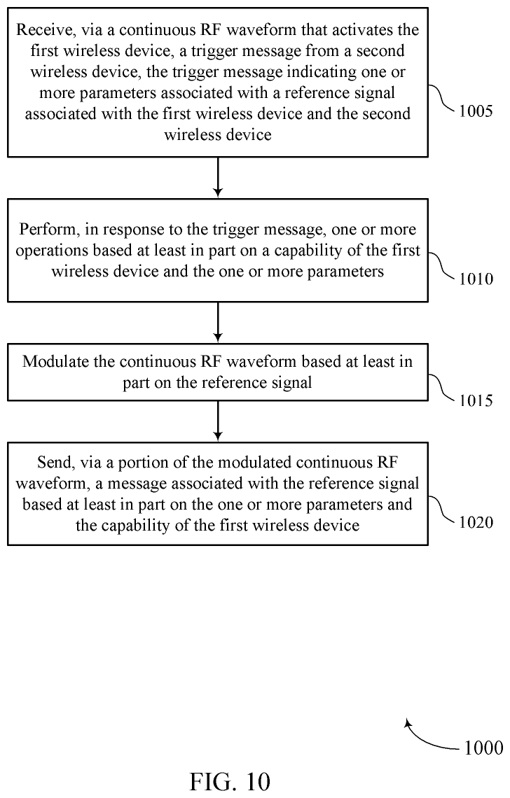

FIG. 10 shows a flowchart illustrating a method 1000 that supports reference signal design for passive wireless devices in accordance with one or more aspects of the present disclosure. The operations of the method 1000 may be implemented by a wireless device or its components as described herein. For example, the operations of the method 1000 may be performed by a wireless device as described with reference to FIGS. 1 through 8. In some examples, a wireless device may execute a set of instructions to control the functional elements of the wireless device to perform the described functions. Additionally, or alternatively, the wireless device may perform aspects of the described functions using special-purpose hardware.

At 1005, the method may include receiving, via a continuous RF waveform that activates the first wireless device, a trigger message from a second wireless device, the trigger message indicating one or more parameters associated with a reference signal associated with the first wireless device and the second wireless device. The operations of 1005 may be performed in accordance with examples as disclosed herein. In some examples, aspects of the operations of 1005 may be performed by a reference signal trigger component 725 as described with reference to FIG. 7.

At 1010, the method may include performing, in response to the trigger message, one or more operations based on a capability of the first wireless device and the one or more parameters. The operations of 1010 may be performed in accordance with examples as disclosed herein. In some examples, aspects of the operations of 1010 may be performed by a reference signal component 735 as described with reference to FIG. 7.

At 1015, the method may include modulating the continuous RF waveform based on the reference signal. The operations of 1015 may be performed in accordance with examples as disclosed herein. In some examples, aspects of the operations of 1015 may be performed by a continuous waveform component 730 as described with reference to FIG. 7.

At 1020, the method may include sending, via a portion of the modulated continuous RF waveform, a message associated with the reference signal based on the one or more parameters and the capability of the first wireless device. The operations of 1020 may be performed in accordance with examples as disclosed herein. In some examples, aspects of the operations of 1020 may be performed by a reference signal component 735 as described with reference to FIG. 7.

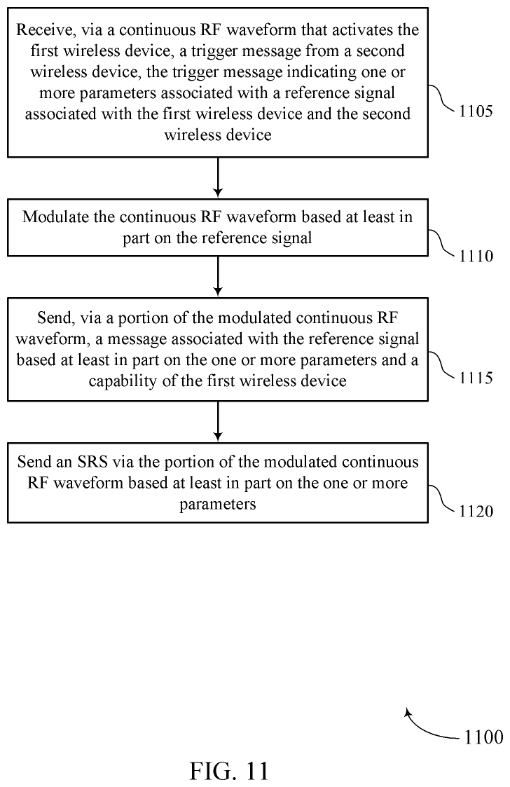

FIG. 11 shows a flowchart illustrating a method 1100 that supports reference signal design for passive wireless devices in accordance with one or more aspects of the present disclosure. The operations of the method 1100 may be implemented by a wireless device or its components as described herein. For example, the operations of the method 1100 may be performed by a wireless device as described with reference to FIGS. 1 through 8. In some examples, a wireless device may execute a set of instructions to control the functional elements of the wireless device to perform the described functions. Additionally, or alternatively, the wireless device may perform aspects of the described functions using special-purpose hardware.

At 1105, the method may include receiving, via a continuous RF waveform that activates the first wireless device, a trigger message from a second wireless device, the trigger message indicating one or more parameters associated with a reference signal associated with the first wireless device and the second wireless device. The operations of 1105 may be performed in accordance with examples as disclosed herein. In some examples, aspects of the operations of 1105 may be performed by a reference signal trigger component 725 as described with reference to FIG. 7.

At 1110, the method may include modulating the continuous RF waveform based on the reference signal. The operations of 1110 may be performed in accordance with examples as disclosed herein. In some examples, aspects of the operations of 1110 may be performed by a continuous waveform component 730 as described with reference to FIG. 7.

At 1115, the method may include sending, via a portion of the modulated continuous RF waveform, a message associated with the reference signal based on the one or more parameters and a capability of the first wireless device. The operations of 1115 may be performed in accordance with examples as disclosed herein. In some examples, aspects of the operations of 1115 may be performed by a reference signal component 735 as described with reference to FIG. 7.

At 1120, the method may include sending an SRS via the portion of the modulated continuous RF waveform based on the one or more parameters. The operations of 1120 may be performed in accordance with examples as disclosed herein. In some examples, aspects of the operations of 1120 may be performed by a reference signal component 735 as described with reference to FIG. 7.

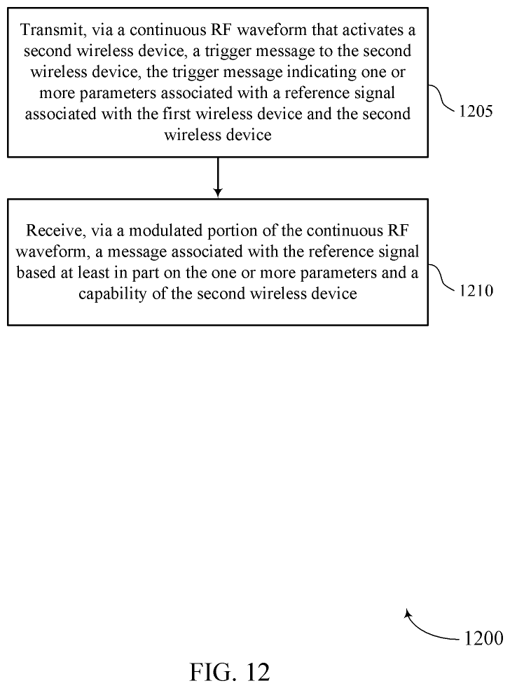

FIG. 12 shows a flowchart illustrating a method 1200 that supports reference signal design for passive wireless devices in accordance with one or more aspects of the present disclosure. The operations of the method 1200 may be implemented by a wireless device or its components as described herein. For example, the operations of the method 1200 may be performed by a wireless device as described with reference to FIGS. 1 through 8. In some examples, a wireless device may execute a set of instructions to control the functional elements of the wireless device to perform the described functions. Additionally, or alternatively, the wireless device may perform aspects of the described functions using special-purpose hardware.

At 1205, the method may include transmitting, via a continuous RF waveform that activates a second wireless device, a trigger message to the second wireless device, the trigger message indicating one or more parameters associated with a reference signal associated with the first wireless device and the second wireless device. The operations of 1205 may be performed in accordance with examples as disclosed herein. In some examples, aspects of the operations of 1205 may be performed by a reference signal trigger manager 740 as described with reference to FIG. 7.

At 1210, the method may include receiving, via a modulated portion of the continuous RF waveform, a message associated with the reference signal based on the one or more parameters and a capability of the second wireless device. The operations of 1210 may be performed in accordance with examples as disclosed herein. In some examples, aspects of the operations of 1210 may be performed by a reference signal manager 745 as described with reference to FIG. 7.

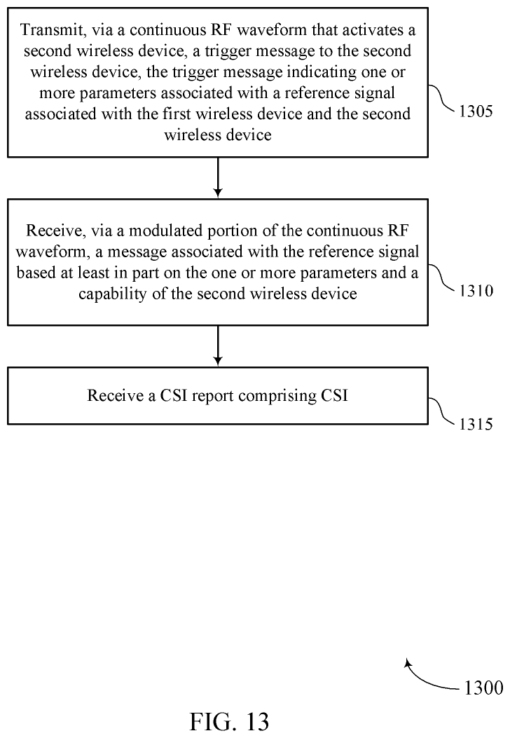

FIG. 13 shows a flowchart illustrating a method 1300 that supports reference signal design for passive wireless devices in accordance with one or more aspects of the present disclosure. The operations of the method 1300 may be implemented by a wireless device or its components as described herein. For example, the operations of the method 1300 may be performed by a wireless device as described with reference to FIGS. 1 through 8. In some examples, a wireless device may execute a set of instructions to control the functional elements of the wireless device to perform the described functions. Additionally, or alternatively, the wireless device may perform aspects of the described functions using special-purpose hardware.

At 1305, the method may include transmitting, via a continuous RF waveform that activates a second wireless device, a trigger message to the second wireless device, the trigger message indicating one or more parameters associated with a reference signal associated with the first wireless device and the second wireless device. The operations of 1305 may be performed in accordance with examples as disclosed herein. In some examples, aspects of the operations of 1305 may be performed by a reference signal trigger manager 740 as described with reference to FIG. 7.

At 1310, the method may include receiving, via a modulated portion of the continuous RF waveform, a message associated with the reference signal based on the one or more parameters and a capability of the second wireless device. The operations of 1310 may be performed in accordance with examples as disclosed herein. In some examples, aspects of the operations of 1310 may be performed by a reference signal manager 745 as described with reference to FIG. 7.

At 1315, the method may include receiving a CSI report including CSI. The operations of 1315 may be performed in accordance with examples as disclosed herein. In some examples, aspects of the operations of 1315 may be performed by a reference signal manager 745 as described with reference to FIG. 7.

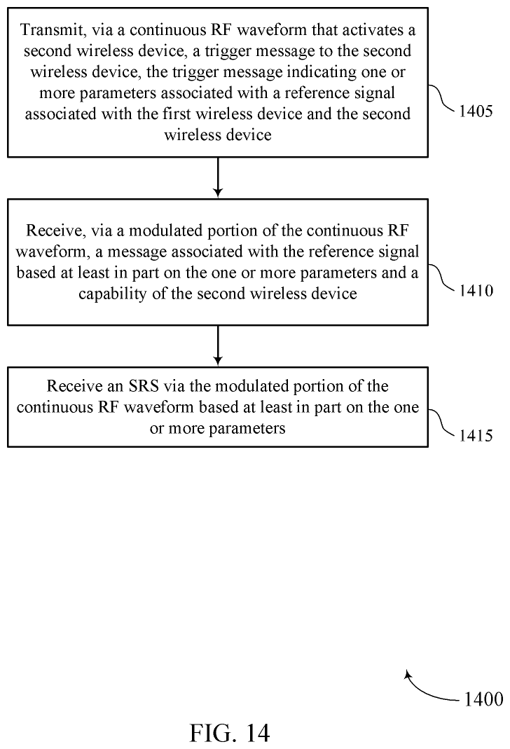

FIG. 14 shows a flowchart illustrating a method 1400 that supports reference signal design for passive wireless devices in accordance with one or more aspects of the present disclosure. The operations of the method 1400 may be implemented by a wireless device or its components as described herein. For example, the operations of the method 1400 may be performed by a wireless device as described with reference to FIGS. 1 through 8. In some examples, a wireless device may execute a set of instructions to control the functional elements of the wireless device to perform the described functions. Additionally, or alternatively, the wireless device may perform aspects of the described functions using special-purpose hardware.

At 1405, the method may include transmitting, via a continuous RF waveform that activates a second wireless device, a trigger message to the second wireless device, the trigger message indicating one or more parameters associated with a reference signal associated with the first wireless device and the second wireless device. The operations of 1405 may be performed in accordance with examples as disclosed herein. In some examples, aspects of the operations of 1405 may be performed by a reference signal trigger manager 740 as described with reference to FIG. 7.

At 1410, the method may include receiving, via a modulated portion of the continuous RF waveform, a message associated with the reference signal based on the one or more parameters and a capability of the second wireless device. The operations of 1410 may be performed in accordance with examples as disclosed herein. In some examples, aspects of the operations of 1410 may be performed by a reference signal manager 745 as described with reference to FIG. 7.

At 1415, the method may include receiving an SRS via the modulated portion of the continuous RF waveform based on the one or more parameters. The operations of 1415 may be performed in accordance with examples as disclosed herein. In some examples, aspects of the operations of 1415 may be performed by a reference signal manager 745 as described with reference to FIG. 7.

The following provides an overview of aspects of the present disclosure:
Aspect 1: A method for wireless communication at a first wireless device, comprising: receiving, via a continuous radio frequency waveform that activates the first wireless device, a trigger message from a second wireless device, the trigger message indicating one or more parameters associated with a reference signal associated with the first wireless device and the second wireless device; modulating the continuous radio frequency waveform based at least in part on the reference signal; and sending, via a portion of the modulated continuous radio frequency waveform, a message associated with the reference signal based at least in part on the one or more parameters and a capability of the first wireless device.
Aspect 2: The method of aspect 1, further comprising: performing, in response to the trigger message, one or more operations based at least in part on the capability of the first wireless device and the one or more parameters.
Aspect 3: The method of aspect 2, wherein performing the one or more operations comprises measuring channel state information associated with the reference signal; and sending the message comprises sending a channel state information report comprising the channel state information.
Aspect 4: The method of any of aspects 1 through 3, wherein sending the message comprises: sending a sounding reference signal via the portion of the modulated continuous radio frequency waveform based at least in part on the one or more parameters.
Aspect 5: The method of any of aspects 1 through 4, further comprising: receiving, via the continuous radio frequency waveform, a capability enquiry message; and sending, via the continuous radio frequency waveform, a capability message indicating the capability of the first wireless device based at least in part on receiving the capability enquiry message.
Aspect 6: The method of any of aspects 1 through 5, wherein receiving the trigger message comprises: receiving the trigger message comprising a scrambling sequence dedicated for the first wireless device, dedicated for the reference signal, or both.
Aspect 7: The method of any of aspects 1 through 6, wherein sending the message comprises: sending a sounding reference signal via the continuous radio frequency waveform during an uplink slot, a downlink slot, or both.
Aspect 8: The method of aspect 7, wherein sending the message comprises: sending a channel state information report via the continuous radio frequency waveform during the uplink slot, the downlink slot, or both.
Aspect 9: The method of any of aspects 1 through 8, further comprising: performing a port sounding procedure associated with the reference signal based at least in part on a quantity of antennas at the first wireless device.
Aspect 10: The method of aspect 9, wherein the one or more parameters indicate an order or a rank for the port sounding procedure.
Aspect 11: The method of any of aspects 1 through 10, wherein the capability of the first wireless device is based at least on a device class associated with one or more reference signal configurations, a first storage for the one or more reference signal configurations, one or more message configurations, a second storage for the one or more message configurations, a sounding reference signal, a port sounding capability, or any combination thereof.
Aspect 12: The method of aspect 11, wherein the one or more message configurations indicates a reference signal sequence, a resource allocation associated with the reference signal, requested content for the message, a charging rate, an input power level, a power measurement, a pathloss measurement, a signal quality measurement, a sounding reference signal trigger, a sounding reference signal sequence, a timing parameter, or any combination thereof.
Aspect 13: The method of any of aspects 11 through 12, wherein sending the message comprises: sending, via the portion of the modulated continuous radio frequency waveform, an indication of at least one of a capacitor size, the device class, a power splitting circuit, a power splitting factor, a condition for performing power splitting, an energy capacity time, and a communication or backscattering time.
Aspect 14: The method of any of aspects 11 through 13, wherein the one or more parameters indicate orthogonal resources in a time or frequency domain based at least in part on the port sounding capability.
Aspect 15: The method of any of aspects 1 through 14, wherein the one or more parameters indicate one or more antenna ports associated with data communication at the first wireless device.
Aspect 16: The method of any of aspects 1 through 15, further comprising: sending, via the portion of the modulated continuous radio frequency waveform, an additional report message indicating an input power level.
Aspect 17: The method of any of aspects 1 through 16, wherein the one or more parameters associated with the reference signal is based at least in part on a memory capability of the first wireless device.
Aspect 18: The method of any of aspects 1 through 17, wherein a memory of the first wireless device is associated with the capability of the first wireless device in a current communication period, a previous communication period, or both.
Aspect 19: A method for wireless communication at a first wireless device, comprising: transmitting, via a continuous radio frequency waveform that activates a second wireless device, a trigger message to the second wireless device, the trigger message indicating one or more parameters associated with a reference signal associated with the first wireless device and the second wireless device; and receiving, via a modulated portion of the continuous radio frequency waveform, a message associated with the reference signal based at least in part on the one or more parameters and a capability of the second wireless device.
Aspect 20: The method of aspect 19, wherein receiving the message comprises: receiving a channel state information report comprising channel state information.
Aspect 21: The method of any of aspects 19 through 20, wherein receiving the message comprises: receiving a sounding reference signal via the modulated portion of the continuous radio frequency waveform based at least in part on the one or more parameters.
Aspect 22: The method of any of aspects 19 through 21, further comprising: transmitting, via the continuous radio frequency waveform, a capability enquiry message; and receiving, via the continuous radio frequency waveform, a capability message indicating the capability of the second wireless device based at least in part on receiving the capability enquiry message.
Aspect 23: The method of any of aspects 19 through 22, wherein transmitting the trigger message comprises: transmitting the trigger message comprising a scrambling sequence dedicated for the second wireless device, dedicated for the reference signal, or both.
Aspect 24: The method of any of aspects 19 through 23, wherein receiving the message comprises: receiving a sounding reference signal via the continuous radio frequency waveform during an uplink slot, a downlink slot, or both.
Aspect 25: The method of aspect 24, wherein receiving the message comprises: receiving a CSI report via the continuous radio frequency waveform during the uplink slot, the downlink slot, or both.
Aspect 26: The method of any of aspects 19 through 25, wherein the one or more parameters indicate an order or a rank for a port sounding procedure at the second wireless device.
Aspect 27: The method of any of aspects 19 through 26, wherein the capability of the second wireless device is based at least on a device class associated with one or more reference signal configurations, a first storage for the one or more reference signal configurations, one or more message configurations, a second storage for the one or more message configurations, a sounding reference signal, a port sounding capability, or any combination thereof.
Aspect 28: The method of aspect 27, wherein the one or more message configurations indicates a reference signal sequence, a resource allocation associated with the reference signal, requested content for the message, a charging rate, an input power level, a power measurement, a pathloss measurement, a signal quality measurement, a sounding reference signal trigger, a sounding reference signal sequence, a timing parameter, or any combination thereof.
Aspect 29: The method of any of aspects 27 through 28, wherein sending the message comprises: receiving, via the modulated portion of the continuous radio frequency waveform, an indication of at least one of a capacitor size, the device class, a power splitting circuit, a power splitting factor, a condition for performing power splitting, an energy capacity time, and a communication or backscattering time.
Aspect 30: The method of any of aspects 27 through 29, wherein the one or more parameters indicate orthogonal resources in a time or frequency domain based at least in part on the port sounding capability.
Aspect 31: The method of any of aspects 19 through 30, wherein the one or more parameters indicate one or more antenna ports associated with data communication at the second wireless device.
Aspect 32: The method of any of aspects 19 through 31, further comprising: receiving, via the modulated portion of the continuous radio frequency waveform, an additional report message indicating an input power level.
Aspect 33: The method of any of aspects 19 through 32, wherein the one or more parameters associated with the reference signal is based at least in part on a memory capability of the second wireless device.
Aspect 34: The method of any of aspects 19 through 33, wherein a memory of the second wireless device is associated with the capability of the second wireless device in a current communication period, a previous communication period, or both.
Aspect 35: An apparatus for wireless communication at a first wireless device, comprising at least one processor and memory coupled with the at least one processor, the memory storing instructions executable by the at least one processor to cause the apparatus to perform a method of any of aspects 1 through 18.
Aspect 36: An apparatus for wireless communication at a first wireless device, comprising at least one means for performing a method of any of aspects 1 through 18.
Aspect 37: A non-transitory computer-readable medium storing code for wireless communication at a first wireless device, the code comprising instructions executable by a processor to perform a method of any of aspects 1 through 18.
Aspect 38: An apparatus for wireless communication at a first wireless device, comprising at least one processor and memory coupled with the at least one processor, the memory storing instructions executable by the at least one processor to cause the apparatus to perform a method of any of aspects 19 through 34.
Aspect 39: An apparatus for wireless communication at a first wireless device, comprising at least one means for performing a method of any of aspects 19 through 34.
Aspect 40: A non-transitory computer-readable medium storing code for wireless communication at a first wireless device, the code comprising instructions executable by a processor to perform a method of any of aspects 19 through 34.

It should be noted that the methods described herein describe possible implementations, and that the operations and the steps may be rearranged or otherwise modified and that other implementations are possible. Further, aspects from two or more of the methods may be combined.

Although aspects of an LTE, LTE-A, LTE-A Pro, or NR system may be described for purposes of example, and LTE, LTE-A, LTE-A Pro, or NR terminology may be used in much of the description, the techniques described herein are applicable beyond LTE, LTE-A, LTE-A Pro, or NR networks. For example, the described techniques may be applicable to various other wireless communications systems such as Ultra Mobile Broadband (UMB), Institute of Electrical and Electronics Engineers (IEEE) 802.11 (Wi-Fi), IEEE 802.16 (WiMAX), IEEE 802.20, Flash-OFDM, as well as other systems and radio technologies, including future systems and radio technologies, not explicitly mentioned herein.

Information and signals described herein may be represented using any of a variety of different technologies and techniques. For example, data, instructions, commands, information, signals, bits, symbols, and chips that may be referenced throughout the description may be represented by voltages, currents, electromagnetic waves, magnetic fields or particles, optical fields or particles, or any combination thereof.

The various illustrative blocks and components described in connection with the disclosure herein may be implemented or performed using a general-purpose processor, a DSP, an ASIC, a CPU, an FPGA or other programmable logic device, discrete gate or transistor logic, discrete hardware components, or any combination thereof designed to perform the functions described herein. A general-purpose processor may be a microprocessor but, in the alternative, the processor may be any processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration). Components within a wireless communication system may be coupled (for example, operatively, communicatively, functionally, electronically, and/or electrically) to each other.

The functions described herein may be implemented using hardware, software executed by a processor, or any combination thereof. If implemented using software executed by a processor, the functions may be stored as or transmitted using one or more instructions or code of a computer-readable medium. Other examples and implementations are within the scope of the disclosure and appended claims. For example, due to the nature of software, functions described herein may be implemented using software executed by a processor, hardware, hardwiring, or combinations of any of these. Features implementing functions may also be physically located at various positions, including being distributed such that portions of functions are implemented at different physical locations.

Computer-readable media includes both non-transitory computer storage media and communication media including any medium that facilitates transfer of a computer program from one location to another. A non-transitory storage medium may be any available medium that may be accessed by a general-purpose or special-purpose computer. By way of example, and not limitation, non-transitory computer-readable media may include RAM, ROM, electrically erasable programmable ROM (EEPROM), phase change memory, flash memory, compact disk (CD) ROM or other optical disk storage, magnetic disk storage or other magnetic storage devices, or any other non-transitory medium that may be used to carry or store desired program code means in the form of instructions or data structures and that may be accessed by a general-purpose or special-purpose computer, or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of computer-readable medium. Disk and disc, as used herein, include CD, laser disc, optical disc, digital versatile disc (DVD), floppy disk and Blu-ray disc. Disks may reproduce data magnetically, and discs may reproduce data optically using lasers. Combinations of the above are also included within the scope of computer-readable media.

As used herein, including in the claims, “or” as used in a list of items (e.g., a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on.” As used herein, the term “and/or,” when used in a list of two or more items, means that any one of the listed items can be employed by itself, or any combination of two or more of the listed items can be employed. For example, if a composition is described as containing components A, B, and/or C, the composition can contain A alone; B alone; C alone; A and B in combination; A and C in combination; B and C in combination; or A, B, and C in combination.

The term “determine” or “determining” encompasses a variety of actions and, therefore, “determining” can include calculating, computing, processing, deriving, investigating, looking up (such as via looking up in a table, a database or another data structure), ascertaining and the like. Also, “determining” can include receiving (e.g., receiving information), accessing (e.g., accessing data stored in memory) and the like. Also, “determining” can include resolving, obtaining, selecting, choosing, establishing, and other such similar actions.

In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label, or other subsequent reference label.

The description set forth herein, in connection with the appended drawings, describes example configurations and does not represent all the examples that may be implemented or that are within the scope of the claims. The term “example” used herein means “serving as an example, instance, or illustration,” and not “preferred” or “advantageous over other examples.” The detailed description includes specific details for the purpose of providing an understanding of the described techniques. These techniques, however, may be practiced without these specific details. In some instances, known structures and devices are shown in block diagram form in order to avoid obscuring the concepts of the described examples.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

1. An apparatus for wireless communication at a first wireless device, comprising:
at least one processor; and
memory coupled with the at least one processor, the memory storing instructions executable by the at least one processor to cause the first wireless device to:
receive, via a continuous radio frequency waveform that activates the first wireless device, a trigger message from a second wireless device, the trigger message indicating one or more parameters associated with a reference signal associated with the first wireless device and the second wireless device;
modulate the continuous radio frequency waveform based at least in part on the reference signal; and
send, via a portion of the modulated continuous radio frequency waveform, a message associated with the reference signal based at least in part on the one or more parameters and a capability of the first wireless device.

2. The apparatus of claim 1, wherein the instructions are further executable by the at least one processor to cause the apparatus to:
perform, in response to the trigger message, one or more operations based at least in part on the capability of the first wireless device and the one or more parameters.

3. The apparatus of claim 2, wherein:
performing the one or more operations comprises measuring channel state information associated with the reference signal; and
sending the message comprises sending a channel state information report comprising the channel state information.

4. The apparatus of claim 1, wherein the instructions to send the message are executable by the at least one processor to cause the apparatus to:
send a sounding reference signal via the portion of the modulated continuous radio frequency waveform based at least in part on the one or more parameters.

5. The apparatus of claim 1, wherein the instructions are further executable by the at least one processor to cause the apparatus to:
receive, via the continuous radio frequency waveform, a capability enquiry message, and
send, via the continuous radio frequency waveform, a capability message indicating the capability of the first wireless device based at least in part on receiving the capability enquiry message.

6. The apparatus of claim 1, wherein the instructions to receive the trigger message are executable by the at least one processor to cause the apparatus to:
receive the trigger message comprising a scrambling sequence dedicated for the first wireless device, dedicated for the reference signal, or both.

7. The apparatus of claim 1, wherein the instructions to send the message are executable by the at least one processor to cause the apparatus to:
send a sounding reference signal via the continuous radio frequency waveform during an uplink slot, a downlink slot, or both.

8. The apparatus of claim 7, wherein the instructions to send the message are executable by the at least one processor to cause the apparatus to:
send a channel state information report via the continuous radio frequency waveform during the uplink slot, the downlink slot, or both.

9. The apparatus of claim 1, wherein the instructions are further executable by the at least one processor to cause the apparatus to:
perform a port sounding procedure associated with the reference signal based at least in part on a quantity of antennas at the first wireless device.

10. The apparatus of claim 9, wherein the one or more parameters indicate an order or a rank for the port sounding procedure.

11. The apparatus of claim 1, wherein the capability of the first wireless device is based at least on a device class associated with one or more reference signal configurations, a first storage for the one or more reference signal configurations, one or more message configurations, a second storage for the one or more message configurations, a sounding reference signal, a port sounding capability, or any combination thereof.

12. The apparatus of claim 11, wherein the one or more message configurations indicates a reference signal sequence, a resource allocation associated with the reference signal, requested content for the message, a charging rate, an input power level, a power measurement, a pathloss measurement, a signal quality measurement, a sounding reference signal trigger, a sounding reference signal sequence, a timing parameter, or any combination thereof.

13. The apparatus of claim 11, wherein the instructions to send the message are executable by the at least one processor to cause the apparatus to:
send, via the portion of the modulated continuous radio frequency waveform, an indication of at least one of a capacitor size, the device class, a power splitting circuit, a power splitting factor, a condition for performing power splitting, an energy capacity time, and a communication or backscattering time.

14. The apparatus of claim 11, wherein the one or more parameters indicate orthogonal resources in a time or frequency domain based at least in part on the port sounding capability.

15. The apparatus of claim 1, wherein the one or more parameters indicate one or more antenna ports associated with data communication at the first wireless device.

16. The apparatus of claim 1, wherein the instructions are further executable by the at least one processor to cause the apparatus to:
send, via the portion of the modulated continuous radio frequency waveform, an additional report message indicating an input power level.

17. The apparatus of claim 1, wherein the one or more parameters associated with the reference signal is based at least in part on a memory capability of the first wireless device.

18. The apparatus of claim 1, wherein a memory of the first wireless device is associated with the capability of the first wireless device in a current communication period, a previous communication period, or both.

19. An apparatus for wireless communication at a first wireless device, comprising:
at least one processor; and
memory coupled with the at least one processor, the memory storing instructions executable by the at least one processor to cause the first wireless device to:
transmit, via a continuous radio frequency waveform that activates a second wireless device, a trigger message to the second wireless device, the trigger message indicating one or more parameters associated with a reference signal associated with the first wireless device and the second wireless device; and
receive, via a modulated portion of the continuous radio frequency waveform, a message associated with the reference signal based at least in part on the one or more parameters and a capability of the second wireless device.

20.-28. (canceled)

29. A method for wireless communication at a first wireless device, comprising:
receiving, via a continuous radio frequency waveform that activates the first wireless device, a trigger message from a second wireless device, the trigger message indicating one or more parameters associated with a reference signal associated with the first wireless device and the second wireless device;
modulating the continuous radio frequency waveform based at least in part on the reference signal; and
sending, via a portion of the modulated continuous radio frequency waveform, a message associated with the reference signal based at least in part on the one or more parameters and a capability of the first wireless device.

30. (canceled)
